(19) United States
(12) Patent Application Publication
(10) Pub. No.: US 2020/0129981 A1
(43) Pub. Date: Apr. 30, 2020

(54) DEVICES AND METHODS FOR SEPARATING PARTICLES

(71) Applicant: University of Georgia Research Foundation, Inc., Athens, GA (US)

(72) Inventors: Leidong MAO, Watkinsville, GA (US); Wujun ZHAO, Athens, GA (US)

(21) Appl. No.: 16/606,872

(22) PCT Filed: Apr. 20, 2018
(86) PCT No.: PCT/US2018/028610

§ 371 Date: Oct. 21, 2019

Related U.S. Application Data
(60) Provisional application No. 62/488,254, filed on Apr. 21, 2017.

(51) Int. Cl. B01L 3/00; G01N 1/28; B03C 1/28; B03C 1/32

(52) U.S. Cl. CPC B01L 3/502761; G01N 1/28; B01L 3/502776; B01L 3/502715; B03C 1/288; B03C 1/32; B03C 2201/26; B01L 2200/0652; B01L 2300/0816; B01L 2300/0681; B01L 2300/0864; B01L 2300/06; B03C 2201/18; B01L 2200/0636

(57) ABSTRACT

Methods and devices for non-invasive, label-free separation of circulating tumors cells in blood are provided. Embodiments of the disclosure provide for devices employing magnetic fluids and magnets for separation of viable circulating tumor cells from blood. Also described are systems for separation and collection of components of fluid including blood.

### CROSS-REFERENCE TO RELATED APPLICATIONS

This application claims the benefit of and priority to U.S. Provisional Application Ser. No. 62/488,254, having the title “DEVICES AND METHODS FOR SEPARATING PARTICLES”, filed on Apr. 21, 2017, the disclosure of which is incorporated herein by reference in its entirety.

### STATEMENT REGARDING FEDERALLY SPONSORED RESEARCH

This invention was made with Government support under Agreement No. R21GM104528, awarded by the National institutes of Health and Grant Nos. 1150042, 1242030, and 1359095, awarded by National Science Foundation. The Government has certain rights in the invention.

### BACKGROUND

Microfluidic particle and cell sorting plays an important role in environmental monitoring, disease diagnostics, and therapeutics. Some techniques include labeling the particle or cell, however, these techniques have disadvantages. Thus, there is a need to develop alternative techniques for particle sorting.

### SUMMARY

Methods for non-invasive, label-free separation of particles in liquid (e.g. fluid), including circulating tumors cells in blood, are provided. Embodiments of the disclosure provide for devices employing magnetic fluids and magnets for separation of circulating tumor cells from blood or fluid containing blood cells. Devices and systems for separation of particles including circulating tumor cells are also provided.

An embodiment of the present disclosure includes a method for separating circulating tumor cells from blood cells in a sample of whole blood. Red blood cells are lysed from the sample to form a first fluid including a cell mixture. The first fluid is introduced to a device having a microfluidic channel with a first end and a second end, where the first fluid is introduced into the microfluidic channel through a first inlet, and the first fluid is flowed through the microfluidic channel. A second fluid including a magnetic fluid is introduced into the microfluidic channel through a second inlet to combine the second fluid with the first fluid to form a third fluid that includes components of the first fluid and the second fluid. The third fluid can be hydrodynamically focused into a sheath flow. The third fluid is exposed to a magnetic field produced by one or more magnets. The components of the third fluid are separated as a function of component size (e.g. diameter, volume) and width of the microfluidic channel. Portions of the components of the third fluid are collected in two or more outlet channels at the second end of the microfluidic channel.

An embodiment of the present disclosure includes a device that includes a microfluidic channel having a first end and a second end. Also included is a first inlet, wherein the first inlet is configured to flow a first fluid into the microfluidic channel; a second inlet located after first inlet, wherein the second inlet is configured to combine a second fluid with the first fluid to create a third fluid, and to hydrodynamically focus the third fluid into a stream by sheath flow. The device includes one or more magnets positioned adjacent and along the length of an area of the microfluidic channel after the first inlet, wherein the magnets are positioned so that the magnetic field produces a magnetization direction substantially perpendicular to the flow of fluid in the microfluidic channel, and wherein the magnet has a flux density of about 0 T to about 10 T and a magnetic field gradient applied to the third fluid is about 0 T/m to about 1000 T/m. Also included in the device can be two or more outlet channels positioned after the one or more permanent magnets at the second end of the microfluidic channel.

Embodiments of the present disclosure provide for a separation and collection system. The system includes a fluid introduction system configured to introduce a first fluid and a second fluid to a microfluidic channel. The fluid introduction system is configured to introduce the first fluid before the second fluid, where the first fluid and the second fluid mix in the microfluidic channel to form a third fluid. The system also includes a magnetic system configured to produce a magnetic field having a magnetization direction substantially perpendicular to the flow of the third fluid in the microfluidic channel after the second fluid is introduced to the microfluidic channel, and the magnet can have a flux density of about 0 T to about 10 T. The system includes a collection system configured to collect one or more components of the third fluid in two or more collection chambers, and each collection chamber is coupled to an outlet channel of the microfluidic channel.

Other structures, methods, systems, compositions, features, and advantages will be, or become, apparent to one with skill in the art upon examination of the following drawings and detailed description. It is intended that all such additional structures, systems, methods, features, and advantages be included within this description, be within the scope of the present disclosure, and be protected by the accompanying claims.

### BRIEF DESCRIPTION OF THE DRAWINGS

Many aspects of this disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1A is a schematic illustration of the separation device with a permanent magnet and a microfluidic channel. Red numbers indicate the outlets. FIG. 1B is an image of the microfluidic device. Magnet was embedded into the PDMS. Black arrows indicate direction of magnet's magnetization. The size of glass slide is 75×50 mm.

FIG. 2A is a cell viability comparison between control group and after separation group using Live/Dead assays. FIGS. 2B and 2C are representative fluorescence images of Live/Dead assays for the H1299 2B and PC-3 2C cells. Control group (top) and after separation group (bottom). Calcein-AM (green) and Ethidium homodimer-1 (red) channels were merged. Scale bars: 100 μm. 2D Long-term culture of H1299 cells after separation. Scale bars: 100 μm.

FIG. 3 shows device calibration with 15.6 μm polystyrene microparticles and white blood cells (WBCs). The stacked image was from 30 consecutive frames, 14 frames/s. Outlets are labeled as red numbers. Scale bar: 500 μm.

FIGS. 4A-C characterize the performance of microfluidic device via a large number of lung cancer cells H1299 (1×10⁵ cells/mL) that were spiked into 1 mL of WBCs. In FIG. 4A, cell mixtures entered and exited the channel together when magnetic fields were not present (top). When the magnetic fields were applied, larger cancer cells were pushed to the Outlet 6 by magnetic buoyancy forces, whereas the smaller WBCs exited through the rest of outlets (bottom). Scale bars: 200 μm. FIG. 4B shows zoomed-in images of 6 outlets when the magnetic fields were present. Scale bars: 100 μm. FIG. 4C is a fluorescence image of cell streaks formed during separation. Lung cancer H1299 cells were stained by CellTracker Green. Red numbers show the outlets. Dashed lines show the microchannel boundaries. Scale bar: 200 μm.

FIG. 5A illustrates separation efficiency of CTCs at different flow rates, the average separation efficiency was 87% and 65% at the flow rate of 20 and 100 μL/min, respectively. 100 H1299 cells were spiked into 1 mL of blood. FIG. 5B are results of a series of spike-in separation experiments in which certain number of H1299 cells were spiked into 1 ml of blood to simulate physiological relevant CTC concentration at a flow rate of 100 μL/min. The average separation efficiency was 67%. FIG. 5C illustrates the separation efficiency of CTCs with multiple cell lines including H1299 (65%), A549 (67%), H3122 (79%), PC-3 (82%), and MDA-MB-231 (79%). 100 CTCs were spiked into 1 mL of blood. FIG. 5D plots the removal rate of WBCs at different flow rates. About 96% WBCs were removed from the spiked samples at the flow rate of 100 μL/min. Error bars indicate s.d., n=3.

FIG. 6A-B are representative micrographs of lung cancer H1299 cells and WBCs after separation. FIG. 6A shows that lung cancer cells and WBCs were found in the outlet reservoir. Scale bars: 100 μm. FIG. 6B shows that lung cancer cells and WBCs were found in the collection chamber. Scale bars: 50 μm.

FIG. 7A is a schematic illustration of an example of traditional and frequently used label-based magnetophoresis for CTC separation, in which rare cells were targeted via specific biomarkers such as epithelial cell adhesion molecule (EpCAM) through functionalized magnetic particles in order to pull these cells through magnetic force towards magnetic field maxima in a continuous-flow manner. FIG. 7B is a schematic of a label-free ferrohydrodynamic cell separation (FCS) for CTCs. In FCS, RBC-lysed blood and biocompatible ferrofluids (colloidal suspensions of magnetic nanoparticles) were processed in continuous flow within a FCS device, such as the one shown in FIGS. 7C and 7D. Cells in blood were first filtered to remove debris, then focused by a ferrofluid sheath flow from inlet B. After entering the channel region that was on top of a permanent magnet, large cells including CTCs and some WBCs experienced more size-dependent magnetic buoyancy force than smaller WBCs, resulting in a spatial separation between them at the outlets of the FCS device. FIG. 7C is an image of an example of the FCS device including a PDMS microchannel and a permanent magnet. The FCS device was connected to a serpentine PDMS collection chamber (right) that was used to accurately count cancer cells or WBCs during FCS calibration experiments using cultured cancer cells. A U.S. quarter was shown for size comparison. Blue dye was used to visualize the channel. FIG. 7D is a schematic of an example of a top-view of the FCS device with labels of inlets, debris filters and outlets. A total of 6 outlets were fabricated in order to account for the broad size distributions of cells (see FIG. 23B). The arrow indicates the direction of magnetic field during device operation.

FIGS. 8A-D show optimization of FCS devices with their device geometry shown in FIGS. 7A-D for high-throughput, high-recovery and biocompatible CTC separation. A 3D analytical model considering magnetic buoyancy force, hydrodynamic drag force, laminar flow profiles and cancer/blood cell physical properties was developed to guide the optimization. The validity of the model was confirmed by comparing its simulated trajectories with experimental ones. Numerical optimization of deflection distance Y_{C} and separation distance ΔY (corresponding to recovery rate and purity) at the end of the FCS device was conducted with parameters including: (FIG. 8A) and (FIG. 8B) magnetic field gradient, and (FIG. 8C) and (FIG. 8D) ferrofluid concentration at flow rates between 1.2 and 7.2 mL h⁻¹. Ferrofluid concentration was fixed at 0.26% (v/v) for FIG. 8A and FIG. 8B. Magnetic field was fixed at 443 mT and its gradient was fixed at 56.2 T m⁻¹ for FIG. 8C and FIG. 8D.

FIGS. 9A-D are micrographs of spiked cancer cells of cell culture lines and undiluted WBCs separation process in a FCS device. In order to image the separation process, 1×10⁵ cells H1299 lung cancer cells were spiked into 1 mL of undiluted WBCs to increase the cancer cell concentration so that their fluorescent signals were visible. The cell mixture was processed at the flow rate of 6 mL h⁻¹. A ferrofluid with its concentration of 0.26% (v/v) was used; magnetic field was fixed at 443 mT and its gradient was fixed at 56.2 T m⁻¹. (FIG. 9A) In absence of magnetic fields, cell mixtures exited the channel through outlets 1 and 2. Scale bar: 200 μm. (FIG. 9B) When magnetic fields were present, larger H1299 lung cancer cells and some WBCs were deflected and exited through outlets 5 and 6 (collection outlets), while smaller WBCs exited through lower outlets (outlets 1-4, waste outlets). Scale bar: 200 μm. (FIG. 9C) Fluorescence image of spiked H1299 lung cancer cell streams during the separation process when magnetic fields were present. H1299 cells were stained by CellTracker Green. Scale bar: 200 μm. (FIG. 9D) Zoomed-in bright-field images of outlets 1-6 when the magnetic fields were present. Scale bars: 100 μm.

FIGS. 10A-D illustrate verification of FCS devices for high-throughput and high-recovery spiked cancer cells separation. (FIG. 10A) Recovery rates of spiked H1299 lung cancer cells from undiluted WBCs at flow rates from 1.2 mL h⁻¹ to 6.0 mL h⁻¹. ˜100 H1299 cancer cells were spiked into 1 ml. of undiluted WBCs. Recovery rates decreased from 98.6±5.0% to 92.3±3.6% when flow rate increased from 1.2 mL h⁻¹ to 6.0 mL h⁻¹. (FIG. 10B) A series of spike-in separation experiments in which a certain number (50, 100, 200, 500, 1000, and 2000) of H1299 cells were spiked into 1 mL of undiluted WBCs to simulate clinically relevant CTC concentration at the flow rate of 6.0 mL h⁻¹. An average recovery rate of 91.9% (linear fit, the coefficient of determination R²=0.9994 was calculated between the number of cells counted and the number of cells spiked) was achieved for H1299 lung cancer cells. (FIG. 10C) The removal rate of WBCs increased with the flow rate. 99.92±2.2% of WBCs were removed at a flow rate of 6 mL h⁻¹. ˜100 H1299 cancer cells were spiked into 1 mL of undiluted WBCs. (FIG. 10D) Recovery rates and purity of separated cancer cells (˜100 cell/mL) for different cancer cell lines at the flow rate of 6 mL h⁻¹. Recovery rates of 92.3±3.6%, 88.3±5.5%, 93.7±5.5%, 95.3±6.0%, 94.7±4.0%, and 93.0±5.3% were achieved for H1299 (lung cancer), A549 (lung cancer), H3122 (lung cancer), PC-3 (prostate cancer), MCF-7 (breast cancer), and HCC1806 (breast cancer) cell lines, respectively. The corresponding purities of cancer cells of each cell line are 11.1±1.2% (H1299), 10.1±1.7% (A549), 12.1±2.1% (H3122), 12.8±1.6% (PC-3), 11.9±1.8 (MCF-7), and 12.2±1.6% (HCC1806), respectively. For all experiments above, a ferrofluid with its concentration of 0.26% (v/v) was used; magnetic field was fixed at 443 mT and its gradient was fixed at 56.2 T m⁻¹. Error bars indicate standard deviation (s.d.), n=3.

FIGS. 11A-D show the effect of FCS on cancer cell viability, proliferation and biomarker expressions. (FIG. 11A) Short-term cell viability comparison before and after FCS process using a Live/Dead assay. Cell viabilities of H1299 lung cancer cells before and after separation process were determined to be 98.9±0.9% and 96.3±0.9%, respectively. Error bars indicate standard deviation (s.d.), n=3. (FIG. 11B) Representative images of Live/Dead cell staining for before (top) and after (bottom) separation groups. Calcein AM (green, live cells) and EhD-1 (red, dead cells) channels were merged. Scale bars: 100 μm (FIG. 11C) Bright field images of cultured 1711299 cells collected after separation from day 1 to day 5. A Live/Dead staining of the cultured cells on day 5 showed excellent cell viability. Scale bars: 50 μm. (FIG. 11D) Comparison of expressions of two key biomarkers (epithelial cell adhesion molecule-EpCAM and cytokeratin-CK) on HCC1806 breast cancer cells before (top) and after (bottom) separation. They showed qualitatively similar EpCAM and CK fluorescence. Scale bars: 20 μm.

FIGS. 12A-C show enrichment of CTCs from NSCLC patient blood using FCS devices, and CTC identification with cytopathology and immunofluorescent staining. CTCs (FIG. 12A) and WBCs (FIG. 12B) from the blood of two NSCLC patients (PA and PB) were enriched by FCS devices and stained with Papanicolaou procedure, then identified by a cytopathologist. (FIG. 12C) Immunofluorescence images of enriched cells from blood samples from patient B. Three channels including CK, EpCAM and CD45 were examined. Cells were identified as CTCs if the staining pattern is CK+/CD45− or EpCAM+/CD45− or CK+/EpCAM+/CD45−, WBC were identified as CK−/EpCAM−/CD45+. Scale bars: 10 μm.

FIG. 13 plots the measured magnetic field and its gradient of the center of magnet's surface vs. distance between the magnet's surface and the microfluidic channel wall.

FIGS. 14A-B are examples of schematic and relevant dimensions of a FCS device. (FIG. 14A) Top-view of the FCS device and relevant dimensions. (FIG. 14B) Cross-section view of the FCS device. The red arrow indicates the direction of permanent magnet's magnetization.

FIG. 15A shows a cell trajectory simulation of H1299 lung cancer cell (16.9 μm) and WBCs (11.1 μm) in a FCS device. FIG. 15B is a zoomed-in view of cell trajectories at the end of an example FCS device. Blue and red trajectories indicate H1299 and WBCs, respectively. Flow rate of cell inlet (Inlet A) was fixed at 6 mL h⁻¹, ferrofluid concentration was fixed at 0.26% (v/v), and magnetic field was fixed at 443 mT and its gradient was fixed at 56.2 T m⁻¹ for this simulation.

FIG. 16 is an example of FCS device calibration with H1299 cells (replaced with beads of similar size, 15.6 μm) and WBCs (11.1 μm). The left-bottom number in each figure indicates the associated flow rate of cell inlet A (mL h⁻¹). Flow rate of cell inlet (Inlet A) was fixed at 6 mL h⁻¹, ferrofluid concentration was fixed at 0.26% (v/v), and magnetic field was fixed at 443 mL and its gradient was fixed at 56.2 T m⁻¹ for this calibration. ˜1×10⁴ polystyrene microparticles were mixed with 1 mL of undiluted WBCs. Scale bars: 500 μm.

FIG. 17 provides a comparison of cell trajectories from calibration experiments and simulations of H1299 cells and WBCs at the end of FCS device. Blue lines are the boundary of the simulated H1299 cell trajectory, and red lines are the boundary of the simulated WBC trajectory. The simulated trajectories considered the initial width of microparticle and cell streams at the entry of the channel, therefore had an up and low bound of trajectories. Overall the simulated trajectories matched well with the experimental calibration trajectories, therefore could be used for subsequent FCS device optimization. Flow rate of cell inlet (Inlet A) was fixed at 6 mL h⁻¹, ferrofluid concentration was fixed at 0.26% (v/v), and magnetic field was fixed at 443 mT and its gradient was fixed at 56.2 T m⁻¹ for simulation and calibration. Scale bar: 500 μm.

FIGS. 18A-F show the characterization of custom-made ferrofluids. (FIG. 18A) Magnetization of the as-synthesized ferrofluid. Solid red lines are the filling of the experimental date to the Langevin function. Saturation magnetization of this ferrofluid was 0.96 kA m⁻¹, corresponding to a 0.26 volume fraction or concentration. (FIG. 18B) Rheological plots of the ferrofluid and blood. The viscosity of ferrofluid was measured to be 2.92 mPa·s. (FIG. 18C) Size distribution of maghemite nanoparticles within the ferrofluid (d=10.25±2.96 nm). (FIG. 18D) Size distribution of maghemite nanoparticles was measured by dynamic light scattering (DLS). Hydrodynamic diameter was 40.77±12.71 nm. (FIG. 18E) Zeta potential of ferrofluid was measured to be −27.2±11.4 mV, indicating a negative surface charge on the particles. (FIG. 18F) A transmission electron microscopy (TEM) image of the maghemite nanoparticles. Scale bar: 20 nm.

FIG. 19A shows cell viability of H1299 lung cancer cells in different concentrations of ferrofluids, evaluated by a MIT assay. Cell viability was 80.8±2.4% after 12-h incubation with a 0.26% (v/v) concentration ferrofluid. (FIG. 19B) Colloidal stability of biocompatible ferrofluids. The maghemite nanoparticles remained colloidally stable for at least 10 months in solution and there was no visible precipitation over time. (FIG. 19C) Blood cells, mixed with a commercial water-based ferrofluid, showed an irreversible flocculation. (FIG. 19D) No flocculation or aggregation of blood cells was found within the biocompatible ferrofluid. Scale bars: 50 μm.

FIG. 20 is an image of an example FCS device and an attached collection chamber. The FCS device was connected to a serpentine collection chamber that was used to accurately enumerate cancer cells for the FCS calibration using cultured cancer cell lines. The depth of collection chamber is 50 μm. The size of the glass slide is 75×50 mm. Blue dye was used to visualize the microchannel.

FIGS. 21A-C are representative micrographs of lung cancer H1299 cells and WBCs after a separation of spiked cancer cells in a FCS device at a throughput of 6 mL h⁻¹. ˜100 CellTracker Green stained H1299 cells were spiked into 1 mL of undiluted WBCs. In FIG. 21A, H1299 lung cancer cells and WBCs were identified in the outlet (outlet 6) reservoir. Scale bars: 100 μm. In FIG. 21B and FIG. 21C, H1299 lung cancer cells and WBCs were identified in the serpentine collection chamber. Scale bars: 50 μm.

FIG. 22 is an example of the cell type distribution of cells collected from outlets 1-6 after a separation of ˜100 H1299 cells spiked into 1 mL of undiluted WBCs using a FCS device at a throughput of 6 mL h⁻¹.

FIG. 23A shows the average cell size of 6 cancer cell lines and WBCs measured by a cell counter. FIG. 23B shows the size distribution of cancer cells and WBCs.

FIGS. 24A-B are representative images of CTC identification from patient A (FIG. 24A) and patient B (FIG. 24B), with their blood processed by FCS devices. Black arrows indicate the CTCs. Scale bars: 50 μm.

FIG. 25 is a schematic representation of an example of a separation and collection system of the present disclosure.

### DISCUSSION

Before the present disclosure is described in greater detail, it is to be understood that this disclosure is not limited to particular embodiments described, as such may, of course, vary. It is also to be understood that the terminology used herein is for the purpose of describing particular embodiments only, and is not intended to be limiting, since the scope of the present disclosure will be limited only by the appended claims.

Where a range of values is provided, it is understood that each intervening value, to the tenth of the unit of the lower limit (unless the context clearly dictates otherwise), between the upper and lower limit of that range, and any other stated or intervening value in that stated range, is encompassed within the disclosure. The upper and lower limits of these smaller ranges may independently be included in the smaller ranges and are also encompassed within the disclosure, subject to any specifically excluded limit in the stated range. Where the stated range includes one or both of the limits, ranges excluding either or both of those included limits are also included in the disclosure.

Unless defined otherwise, all technical and scientific terms used herein have the same meaning as commonly understood by one of ordinary skill in the art to which this disclosure belongs. Although any methods and materials similar or equivalent to those described herein can also be used in the practice or testing of the present disclosure, the preferred methods and materials are now described.

As will be apparent to those of skill in the art upon reading this disclosure, each of the individual embodiments described and illustrated herein has discrete components and features which may be readily separated from or combined with the features of any of the other several embodiments without departing from the scope or spirit of the present disclosure. Any recited method can be carried out in the order of events recited or in any other order that is logically possible.

Embodiments of the present disclosure will employ, unless otherwise indicated, techniques of chemistry, material science, and the like, which are within the skill of the art. Such techniques are explained fully in the literature.

The following examples are put forth so as to provide those of ordinary skill in the art with a complete disclosure and description of how to perform the methods and use the compositions and compounds disclosed and claimed herein. Efforts have been made to ensure accuracy with respect to numbers (e.g., amounts, temperature, etc.), but some errors and deviations should be accounted for. Unless indicated otherwise, parts are parts by weight, temperature is in ° C., and pressure is in atmosphere. Standard temperature and pressure are defined as 25° C. and 1 atmosphere.

Before the embodiments of the present disclosure are described in detail, it is to be understood that, unless otherwise indicated, the present disclosure is not limited to particular materials, reagents, reaction materials, manufacturing processes, or the like, as such can vary. It is also to be understood that the terminology used herein is for purposes of describing particular embodiments only, and is not intended to be limiting. It is also possible in the present disclosure that steps can be executed in different sequence where this is logically possible.

It must be noted that, as used in the specification and the appended claims, the singular forms “a,” , and “the” include plural referents unless the context clearly dictates otherwise. Thus, for example, reference to “a support” includes a plurality of supports. In this specification and in the claims that follow, reference will be made to a number of terms that shall be defined to have the following meanings unless a contrary intention is apparent.

### Definitions

A biocompatible substance or fluid, as described herein, indicates that the substance or fluid does not adversely affect the short-term viability or long-term proliferation of a target cell within a particular time range.

Curved or curve, as described herein, indicates a non-linear shape, where curved can include a single curve, multiple curves, and multi-directional curves, including crescent-shaped, serpentine, and the like.

### Discussion

Embodiments of the present disclosure provide for devices, methods, and separation and collection systems for separating particles, especially cells such as blood or tumor cells, and the like. An embodiment of the present disclosure is advantageous because it has a very high sorting efficiency (e.g., about 90% or more, about 99% or more, about 99.9% or more) and a very high throughput (e.g., about 10⁷ cells/hour or more, about 10⁸ cells/how or more) In addition, the device is less expensive than other techniques (e.g., FACS) and is straightforward to operate. Embodiments of the present disclosure are advantageous in that neither short-term cell viability nor long-term proliferation of cells are impacted.

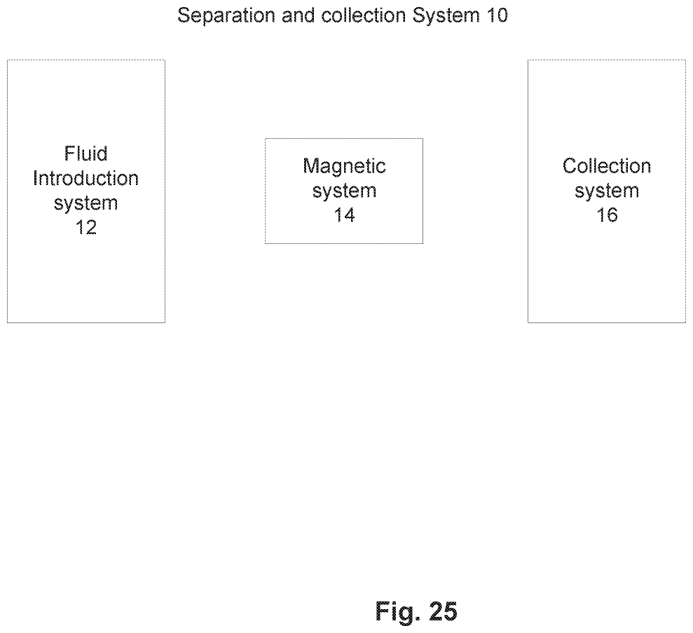

In general, embodiments of the present disclosure include non-uniform magnetic field-assisted systems, methods, and devices for the separation of particles (e.g., cells) within a magnetic fluid. FIG. 25 is a schematic representation of an example of a separation and collection system 10 of the present disclosure that includes a fluid introduction system 12, magnetic system 14, and a collection system 16. In the separation and collection system 10, under non-uniform magnetic fields, particles such as cells can experience the generated magnetic field direction to produce a magnetic buoyancy force, analogous to buoyancy force, as magnitude of the force is proportional to the volume of cell. This force can be used to spatially separate cells of different sizes in certain flow conditions (e.g., laminar flow and/or shear flow).

Embodiments of the present disclosure can be label-free and/or do not require time-consuming steps of magnetic beads conjugation. Although some systems claim to be label-free, embodiments of the present disclosure are completely label-free.

Embodiments of the present disclosure include high-efficiency and high-throughput continuous-flow particle separation and focusing systems and devices using magnetic fluid (e.g., ferrofluids) and magnets (e.g., permanent magnets). Permanent magnet based devices are low-cost and easy to operate and their operation does not generate heat. Magnetic fields produced by permanent magnets are substantially larger than the ones by current-carrying electrodes, which can increase the sorting throughput and efficiency of embodiments of the present disclosure. Embodiments of the present disclosure provide for devices and systems that can easily fit onto a normal glass microscope slide for ease of observation under the microscope.

In an aspect, the separation and collection system 10 can include a fluid introduction system 12 configured to introduce a first fluid and a second fluid to a microfluidic channel, while the magnetic system 14 is configured to produce a magnetic field having a magnetization direction substantially perpendicular to the flow of the fluid (e.g., components of the fluid) in the curved microfluidic channel. The collection system 16 can collect portions of the fluid as they flow out of two or more channels of the microfluidic channel.

In an aspect, the fluid introduction system 12 is configured to introduce a first fluid and the fluid introduction system is also configured to introduce a second fluid after first inlet, where the first fluid and the second fluid mix in the microfluidic channel to form a third fluid.

In an aspect, the magnetic system 14 configured to produce a magnetic field having a magnetization direction substantially perpendicular to the flow of the third fluid in the microfluidic channel after the second fluid is introduced to the microfluidic channel. In an aspect, the magnet can have a flux density of about 0 T to about 10 T. In an embodiment, the magnet can have a magnetic gradient of about 0 to about 1000 T/m.

In an aspect, the collection system 16 is configured to collect one or more components of the third fluid in two or more collection chambers, where each collection chamber is coupled to an outlet channel of the microfluidic channel.

Now having described aspects of the present disclosure in general, additional details will be provided.

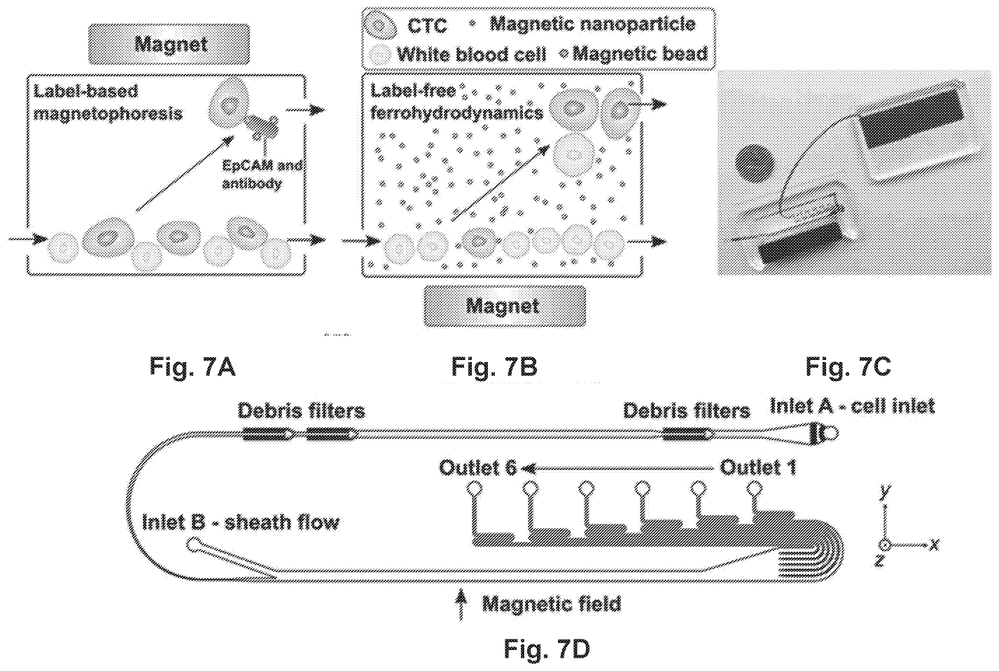

Embodiments of the present disclosure provide for systems, devices, and methods for separating circulating tumor cells from blood cells in a sample of whole blood. These include lysing red blood cells from the sample to form a first fluid that includes a cell mixture. The first fluid is introduced to a structure having a microfluidic channel (e.g. a curved, straight, or angled channel) that has a first end and a second end. The first fluid is introduced into the microfluidic channel through a first inlet located before the second inlet. The first fluid is flowed through the microfluidic channel. A second fluid, which includes a magnetic fluid, is introduced into the microfluidic channel through a second inlet located after the first inlet to combine the second fluid with the first fluid to form a third fluid. The third fluid includes components of the first fluid and the second fluid. The third fluid is hydrodynamically focused into a sheath flow. The third fluid is exposed to a magnetic field produced by one or more magnets positioned adjacent and along a length of an area of the microfluidic channel. Illustrative embodiments of the device are shown in FIGS. 7C and 7D. The components of the third fluid are separated as a function of component size (e.g. the diameter of cells, volume of the cell or particle) and width of the microfluidic channel. For clarity, the microfluidic channel may be described as a curved microfluidic channel, but it should be understood that the channel may have various shapes or paths, including but not limited to straight, one or more angles or curves (e.g. polygonal, having one or more right, acute and/or obtuse angles), serpentine, and the like.

In an aspect, the magnets have a flux density of about 0 T to about 10 T, or about 0.1 to about 1.0 T, and the magnetic field produces a magnetization direction substantially perpendicular to the flow of the third fluid in the curved microfluidic channel. In an aspect, two or more outlet channels can positioned after the one or more magnets (e.g., permanent magnet) at the second end of the curved microfluidic channel.

In an aspect, portions of the components of the third fluid can be collected in two or more outlet channels positioned after the one or more permanent magnets at the second end of the curved microfluidic channel.

In an embodiment, the first fluid can include a plurality of components, for example a cell mixture (e.g. white blood cells and circulating tumor cells). In another embodiment, the first fluid can include both a magnetic fluid (e.g. a ferrofluid) and the cell mixture. In an embodiment, the cells can include cancer cells, bacterial cells, yeast cells, blood cells, cancer cells, neural cells, sperm cells, eggs, as well as types of cells that have size difference can be distinguished by this technique. In an embodiment, the volume of the cells can be about 5 to 3000 μm³. In embodiments, the circulating tumor cells can be from cancers (e.g. lung cancer, prostate cancer, breast cancer, and pancreatic cancer). In an embodiment, the circulating tumor cells are unlabeled.

In an embodiment, the components can experience non-uniform magnetic force and are biologically compatible with the magnetic fluid. In particular, the components can be separated by the magnetic buoyancy force exerted upon them. In an embodiment, the fluid is exposed to a non-uniform magnetic force generated by a magnetic device. In an embodiment, the components experience a magnetic buoyancy force that causes the components to separate from one another based on the volume of the components.

In an embodiment, the magnetic fluid can be a ferrofluid including magnetic particles, wherein the ferrofluid concentration is tunable from about 0% to 10% volume fraction of the magnetic particles in the ferrofluid. The concentration is tuned based on the size and volume fraction of the components of the magnetic particles. In an embodiment, the ferrofluid concentration is tunable from about 0.2% to 0.3%, or about 0.26% volume fraction of the magnetic particles in the ferrofluid. In an embodiment, the magnetic fluid can be a ferrofluid, paramagnetic solution, or a combination thereof. In an embodiment, the magnetic fluid can be a colloidal mixture of nano-size magnetic particles (e.g., about 5 to 20 nm in diameter), covered by a surfactant, suspended in a compatible carrier medium. The magnetic particles can be iron oxide particles, cobalt particles, cobalt ferrite particles, iron particles, FePt particles, or a combination thereof, where the amount of the magnetic particles in the magnetic fluid can be about 0% (v/v) to 10% (v/v). The surfactant can include an electric double layer surfactant, polymer surfactant, inorganic surfactant, or a combination thereof. The carrier medium can be water, hydrocarbon oil, kerosene, or a combination thereof. In an embodiment, the magnetic fluid can include maghemite nanoparticles, a polymer surfactant (e.g., and the carrier can be water. In an embodiment, the magnetic fluid can include maghemite nanoparticles (Fe₂O₃) coated with polymethyl methacrylate. polyethylene glycol (PMMA-PEG) and 10% (v/v) 10× Hank's balanced salt solution (HESS).

In an embodiment, about 6.0 mL to about 7.0 mL can be processed in about one hour. In an embodiment, the flow rate can be about 1.2 to about 7.2 mL h⁻¹, or about 6.0 mL h⁻¹. In other embodiments, higher throughputs can be obtained (e.g. by including multiple channels, device scaling, and device multiplexing). Device scaling can be achieved by changing the depth of the channel and corresponding magnetic field flux density and gradient. Device multiplexing can be achieved by dividing the input flows equally to multiple devices that have same dimensions and geometries.

In an embodiment, about 88% or more of the circulating tumor cells are recovered. Advantageously, about 80% or more of the recovered cells are viable, and proliferation of the cells and their biomarkers are unaffected.

In an embodiment, the first fluid can be filtered before the second fluid is introduced. In an embodiment, the microfluidic channel includes one or more filtration regions after the first inlet and prior to the second inlet. In an embodiment, the filtration region includes one or more filters. In an embodiment, the filter(s) can function to remove large debris or fibrin or irrelevant components in blood for this particular analysis. In an embodiment, the filter can include a type of filter for blood that can remove large debris or fibrin and the like, and can fit within the dimensions of the microfluidic channel. In an embodiment, the filter(s) can include a two-row array of 36 S-shaped filters with 18 in each row. In an embodiment, 2 or more filters can be used and the distance between each filter can be about 10 to 40 μm or about 30 μm.

In an embodiment, the microfluidic channel can have a width of about 100 μm to about 1 cm, a depth of about 10 μm to about 1 mm, and a length of about 1 cm to about 10 cm. In various embodiments, the dimensions of the microfluidic channel can be designed to optimize the separation of particles and/or cells. In one such embodiment, the microfluidic channel can have a constant height and width along its length. In another embodiment, the microfluidic channel widens (e.g., the width can gradually widen to 1.5 to 100 times the width of the channel prior to widening) after the first inlet. In another embodiment, the microfluidic channel can be tapered.

In an embodiment, the outlet channels can have the same or different dimensions (e.g., diameter, length, width, height), and each can independently have a diameter, length, width, and/or height at the opening of about 10 μm to about 1 cm, or of about of about 500 μm to about 2000 μm. In an embodiment, the outlet channels can be designed (e.g., dimension, three-dimensional orientation relative to the channel (e.g., offset from the axis of the channel), and the like) to enhance the separation of the particles.

In an embodiment, additional inlets can be present to introduce other reagents or fluids, and these can be staged anywhere along the length of the channel.

In an embodiment, the first fluid can be flowed in the first inlet and the magnetic fluid can be flowed in a second inlet and the two fluids mix. In an embodiment, the flow rate of the fluid(s) can be controlled and the flow rate can be used to enhance the separation. In an embodiment, the magnetic fluid can be flowed through the first inlet and the first fluid flowed through the second inlet. The fluid (e.g., first, second, and third) can be flowed at rates of about 0 mL/hour to 100 mL/hour.

In an embodiment, the one or more magnets are configured adjacent to the microfluidic channel at a position such that the magnetic field gradient applied to the third fluid is about 0 T/m to about 1000 T/m, or about 3 T/m to about 100 T/m, or about 5.62 T/m. The strength of the magnetic field can be selected based upon the configuration of the device, the particles to be separated (e.g., the volume of the particles), and the like. In another embodiment, the magnetic device includes two or more magnets (e.g., 3, 4, 5, 6, 7, and so on) that can be used to form a non-uniform magnetic field within an area of the channel. The design, number of magnets used, the non-uniform magnetic field generated, and the like, can be designed to separate particles.

In an embodiment, one or more collection chambers can be coupled to the outlet channels so that each portion of the fluid can be separately collected. Once collected, one or more portions collected can be analyzed or processed again through the same system or a second system operated in serial to further enhance separation.

In an exemplary embodiment, the magnet is configured to direct a non-uniform magnetic force onto particles is positioned at a point of the microfluidic channel (e.g. a curved, straight, or angled channel). In an embodiment, the magnet can be positioned relative to the split or space from the curve of the curved microfluidic channel to the outlets. In an embodiment, the magnet is configured to direct the non-uniform magnetic force onto particles from one side of the channel. As noted above, the design of the device (e.g., the position of the magnet and/or the outlets) can take into consideration the various components, the particles to be separated, and/or the magnetic fluid, to achieve the desired separation efficiency and/or throughput.

As noted above, the device includes a plurality of outlets (e.g. outlet channels). Once the non-uniform magnetic force acts upon the components (e.g., particles (e.g., cells in the blood)), the components flow in the third fluid is altered so that certain types of components flow into one outlet and another type of components flows into a different outlet.

In an embodiment where many different types of components (e.g., particles) to be separated, then the outlets can be spaced apart along the length of the curved microfluidic channel and/or more than one magnet can be used along the length of the curved microfluidic channel in conjunction with the spacing of the outlet. Many different types of configurations are envisioned that are consistent with the teachings of the present disclosure and are intended to be covered by claims of this and future application.

As mentioned above, embodiments of the present disclosures can include a method for separating circulating tumor cells from blood cells in a sample of whole blood, where the device described herein can be used to perform steps of the method. In an embodiment, the method includes introducing whole blood or a fluid including whole blood to the device through an inlet and flowing the whole blood through a curved microfluidic channel. Components from the whole blood are passed through one or more filters to form a filtered fluid. In an embodiment, a magnetic fluid is introduced into the curved microfluidic channel through a second inlet to combine with the whole blood forming a third fluid. The third fluid is hydrodynamically focused into a sheath flow. The third fluid is introduced to a magnetic field, where the magnetic field produces a magnetization direction perpendicular to the flow of filtered fluid in the curved microfluidic channel.

In an embodiment, this process can be repeated for the components that are separated to increase efficiency and/or separate components having similar characteristics (e.g., volume, cell diameter). For example, the separated flow can be recirculated through the same curved microfluidic channel or can be flowed through a different channel. The device may include two or more curved microfluidic channels and/or magnets.

### EXAMPLES

Now having described the embodiments of the disclosure, in general, the example describes some additional embodiments. While embodiments of the present disclosure are described in connection with the example and the corresponding text and figures, there is no intent to limit embodiments of the disclosure to these descriptions. On the contrary, the intent is to cover all alternatives, modifications, and equivalents included within the spirit and scope of embodiments of the present disclosure.

### Example 1

### Introduction

Circulating tumor cells (CTCs), which are cells that cast from primary tumors and disseminated through the blood to other organs, enable frequent and minimally invasive access to tumor samples and promise a new approach in monitoring cancer treatment.¹ CTCs are essential in oncology as they serve as a liquid biopsy target in cancer diagnosis and prognosis, as well as in assessing the efficacy of treatment.^{2, 3} Lung cancer, especially non-small cell lung cancer (NSCLC), is the leading cause of cancer deaths in the United States, Currently, NSCLC patients must undergo bronchoscopy or computed tomography (CT)-guided biopsy for tissue diagnosis or to understand the mechanism of treatment resistance. However, these methods are invasive, expensive, uncomfortable, and have risks of bleeding, pneumothorax, and radiation, and therefore cannot be used frequently. The use of CTCs as a liquid biopsy would permit repeated and painless sampling of tumor cells for the same molecular assays performed on traditional biopsies.^{4, 6} Moreover, changes in the number of CTCs in the blood, as well as in their genome, after initiation of treatment can help identify whether the tumor, including NSCLC,^{7, 8} is responding to the treatment,⁹⁻¹¹ so that the mechanism of drug resistance might be deciphered. Together, this evidence suggests that capturing CTCs will be an attractive first step to understand the prognostic and predictive markers of responder versus nonresponder. This concept provides a radical departure from current approaches. The precise counting of CTCs in the blood circulation may constitute a very powerful tool to monitor treatment efficacy of NSCLC, but it also requires the development of highly sensitive, high-throughput, and low-cost separation technology. However, CTCs are extremely rare in the blood circulation, occurring at a concentration of 1-100 CTCs per milliliter of blood.⁵ These cells are dispersed in a background of billions of red blood cells (RBCS) and millions of WBCs, making the separation of CTCs a significant challenge, Most of the existing methods for CTC capture are either expensive, tedious, and requiring multiple additional labels to identify the CTCs or having low throughput and low purity.^{8, 12} Therefor, there is a critical need to develop label-free, high-throughput, high-efficiency, and low-cost technologies for CTC separation that will keep CTCs alive for further molecular analysis.

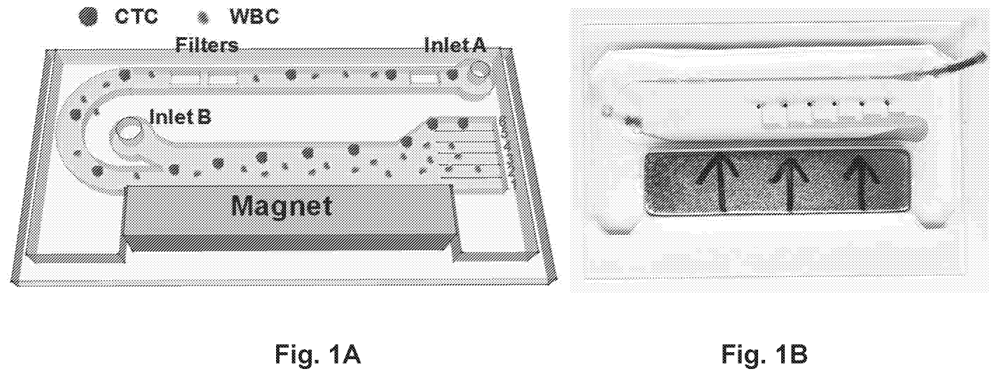

Here, we introduce a microfluidic CTC separation technology, which uses biocompatible ferrofluid hydrodynamics (ferrohydrodynamics)¹³ to separate the CTCs (lung, prostate and breast cancer cells) from other blood cells, addresses the limitations of other separation techniques with its low cost of production, ease of use, high throughput and high efficiency. Ferrofluids are stable magnetic nanoparticles suspensions used as media in microfluidics for CTC separation.¹³ The ferrofluid we developed here is biocompatible that can sustain the viability of target cells for up to several hours with excellent colloidal stability and tunable concentration to allow for cell observation without fluorescent labels.¹⁴ The separation device consists of a microchannel and a permanent magnet. The working mechanism of the device is shown in FIG. 1A. Cell mixtures and ferrofluids are introduced into the channel by a pressure-driven flow. When the magnet is not present near the channel, both CTCs and blood cells enter and exit the channel together, resulting in no separation. When the magnet is placed close to the channel, deflections of cells from their laminar flow paths occur because of the magnetic buoyancy force. The force acting on cells inside ferrofluids is a body three and proportional to the volume of cells, which leads to a spatial separation of cells of different sizes at the end of microchannel. As a result, larger CTCs and smaller blood cells exit through different outlets.

### Experimental

The microfluidic device was fabricated through a standard soft-lithography approach with polydimethylsiloxane (PDMS) layer bonded with a cover glass.¹⁵ A removable NdFeB permanent magnet was placed next to PDMS, which was 1 mm away from the channel with the magnetization direction perpendicular to the channel (FIG. 1B). Ferrofluids were synthesized by chemical co-precipitation method then coated with polymethyl methacrylate-polyethylene glycol (PMMA-PEG).^{14 ,16} Cancer cells (H1299, A549, H3122, PC-3, and MDA-MB-231) were cultured by standard methods. WBCs were prepared by directly lysing of 1 mL of human whole blood and resuspended into 1 mL ferrofluids. CTCs were simulated by spiking 50-2000 CellTracker Green stained cancer cells into 1 mL of WBCs and introduced into Inlet A (FIG. 1A) at a constant flow rate of 100 μL/min, and hydrodynamically focused by a sheath flow from Inlet B at a flow rate of ˜120 μL/min. The separated samples were collected into a serpentine collection channel, which was used to accurately enumerate CTCs for the spiked samples after separation.

### Results and Discussion

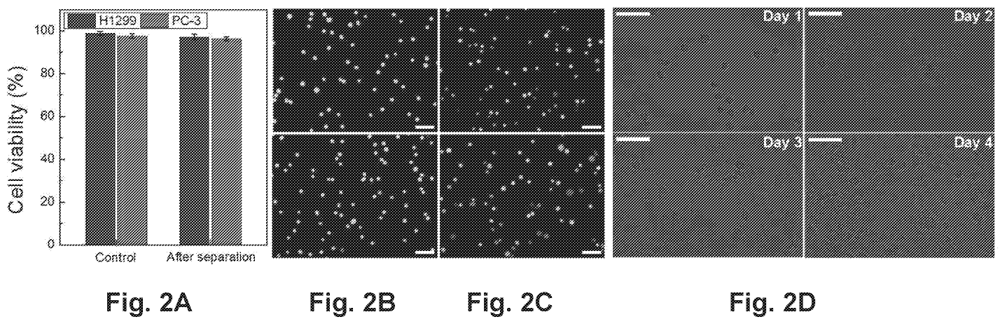

To study the impact of separation platform on cell viability, we first examined both short-term and long-term proliferation after separation. FIGS. 2A-D show that no significant difference was found between control group and after separation group for the short-term viability. Cells were able to spread and grow to confluence after separation. We thus conclude that this separation platform does not have a significant impact on short-term cell viability or long-term proliferation of cells.

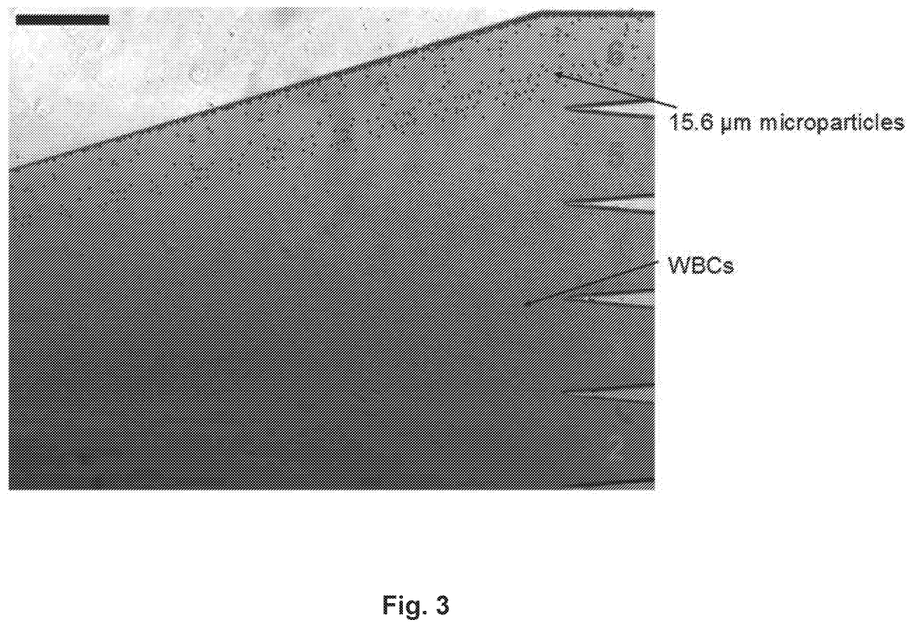

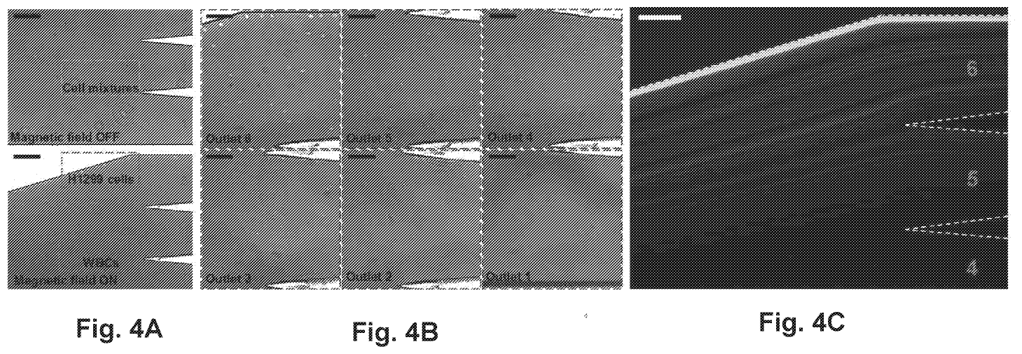

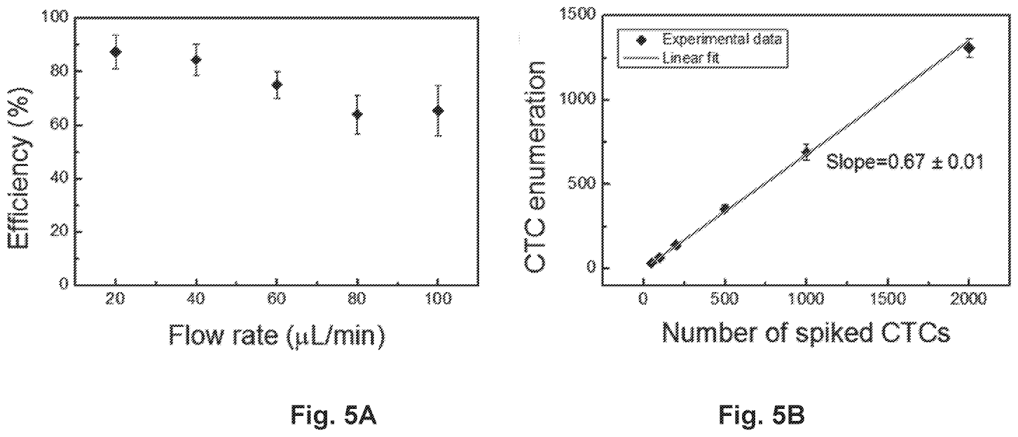

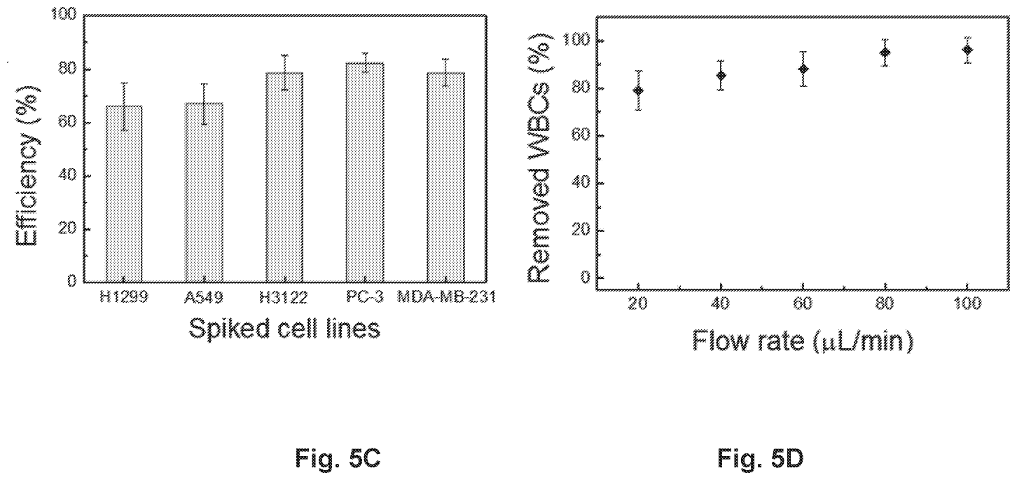

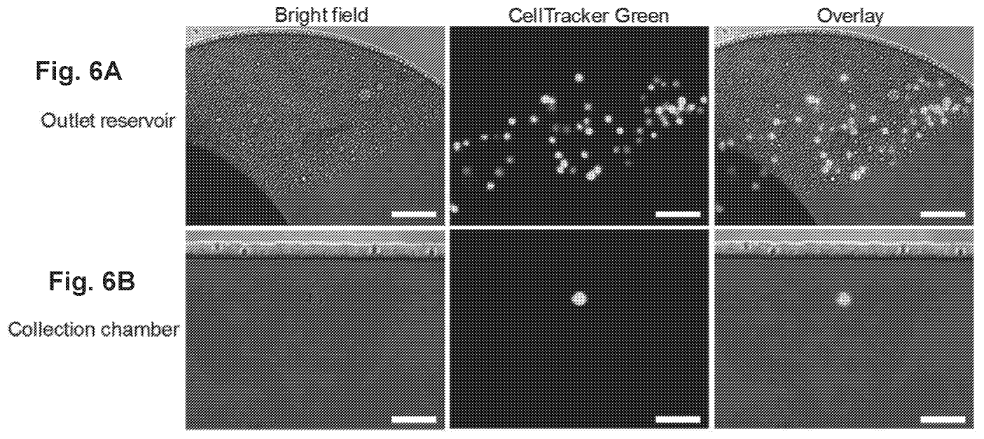

In order to optimize the flow rates for cell separation, we first calibrated the device using polystyrene microparticles with diameter of 15.8 μm (FIG. 3). Recovery rate is defined as the ratio of number of CTCs obtained in Outlet 6 to the number of total CTCs spiked into the blood. FIGS. 4A-C show the micrographs of the separation process with magnetic fields on and off. When the magnetic fields were applied, larger CTCs were pushed to the Outlet 6, whereas the smaller WBCs still remained in Outlets 1-5. FIGS. 5A-D summarize the separation efficiency and removal rate of WBCs at different flow rates. The separation efficiency was 65% and the WBC removal rate was 96% at the flow rate of 100 μL/min for the H1299 cells (FIGS. 5A and 5D). In order to simulate physiological relevant CTC concentration in patient blood, we carried out a series of spike-in (50-2000 CTCs/mL) separation experiments. The average separation efficiency was 67%, which is consistent with the previous results (FIG. 5B). FIG. 5C shows the separation efficiency of multiple cell lines, including lung, prostate, and breast cancer cell lines. We achieved the separation efficiency up to 86% for the PC-3 cells. The cell counting results of lung cancer cell lines are summarized in Table 1 and representative images of cell counting form outlet reservoir and collection chamber are shown in FIGS. 6A-B.

TABLE 1
Cell separation with multiple-spiked lung cancer cell lines. 100 CTCs were spiked into 1 mL
of blood. The flow rate was 100 μL/min. Cells were collected from each outlet and enumerated under
the fluorescence microscopy.

| | | No. of cells | No. of cells | No. of cells | No. of cells | No. of cells | No. of cells | |
|---|---|---|---|---|---|---|---|---|
| | No. of cells | collected | collected | collected | collected | collected | collected | Capture |
| Cell line | spiked | (Outlet 6) | (Outlet 5) | (Outlet 4) | (Outlet 3) | (Outlet 2) | (Outlet 1) | efficiency |
| H1299 | ~100 | 76 | 16 | 6 | 0 | 0 | 0 | 76% |
| H1299 | ~100 | 60 | 28 | 18 | 1 | 0 | 0 | 60% |
| H1299 | ~100 | 62 | 20 | 14 | 2 | 0 | 0 | 62% |
| A549 | ~100 | 75 | 18 | 3 | 0 | 0 | 0 | 75% |
| A549 | ~100 | 66 | 22 | 13 | 0 | 0 | 0 | 66% |
| A549 | ~100 | 60 | 21 | 11 | 3 | 0 | 0 | 60% |
| H3122 | ~100 | 72 | 20 | 12 | 0 | 0 | 0 | 72% |
| H3122 | ~100 | 85 | 13 | 4 | 0 | 0 | 0 | 85% |
| H3122 | ~100 | 79 | 8 | 10 | 0 | 0 | 0 | 79% |

### Conclusion

We have developed a biocompatible ferrofluid that can sustain the target cells for up to several hours with excellent colloidal stability and tunable concentration to allow for cell observation without labels. We apply this ferrofluid in the continuous-flow separation of CTCs and human blood cells, rendering high throughput and moderate separation efficiency. The developed microfluidic device is capable of processing 6 mL blood per hour with the separation efficiency of 60%-86%. Our method provides significant potential to monitor the phenotypic and genotypic changes in CTCs of cancer patients due to its label-free feature.

### References for Example 1

1. C. Aggarwal, N. J. Meropol, C. J. Punt, N. Iannotti, B. H. Saidman, K. D. Sabbath, N. Y. Gabrail, J. Picus, M. A. Morse, E. Mitchell, M. C. Miller and S. J. Cohen, Ann Oncol, 2013, 24, 420-428.
2. S. Mocellin, D. Hoon, A. Ambrosi, D. Nitti and C. R. Rossi, Clin Cancer Res, 2006, 12, 4605-4613.
3. S. Braun and C. Marth, New Engl J Med, 2004, 351 824-826.
4. S. Paget, Cancer metastasis reviews, 1989, 8, 98-101.
5. C. Alix-Panabieres and K. Pantel, Clinical chemistry, 2013, 59, 110-118.
6. K. Pantel and C. Alix-Panabieres, Trends Mol Med, 2010, 16, 398-406.
7. M. G. Krebs, R. Sloane, L. Priest, L. Lancashire, J. M. Hou, A. Greystoke, T. H. Ward, R. Ferraldeschi, A. Hughes, G. Clack, M. Ranson, C. Dive and F. H. Blackhall, J Clin Oncol, 2011, 29, 1556-1563.
8 S. Nagrath, L. V. Sequist, S. Maheswaran, D. W. Bell, D. Irimia, L. Ulkus, M. R. Smith, E. L. Kwak, S. Digumarthy, A. Muzikansky, P. Ryan, U. J. Balis, R. G. Tompkins, D. A. Haber and M. Toner, Nature, 2007, 450, 1235-U1210.
9. M. Cristofanilli, K. R. Broglio, V. Guarneri, S. Jackson, H. A. Fritsehe, R. Islam, S. Dawood, J. M. Reuben, S. W. Kau, J. M. Lara, S. Krishnamurthy N. T. Ueno, G. N. Hortobagyi and V. Valero, Clin Breast Cancer, 2007, 7, 471-479.
10. M. Cristofanilli, G. T. Budd, M. J. Ellis, A. Stopeck, J. Matera, M. C. Miller, J. M. Reuben, G. V. Doyle, W. J. Allard, L. W. M. M. Terstappen and D. F. Hayes, New Engl J Med, 2004, 351, 781-791.
11. D. C. Danila, G. Heller, G. A. Gignac, R. Gonzalez-Espinoza, A. Anand, E. Tanaka, H. Lilja, L. Schwartz, S. Larson, M. Fleisher and H. I. Scher, Clin Cancer Res, 2007, 13, 7053-7058.
12. S. L. Stott, C. H. Hsu, D. I. Tsukrov, M. Yu, D. T. Miyamoto, B. A. Waltman, S. M. Rothenberg, A. M. Shah, M. E. Smas, G. K. Korir, F. P. Floyd, A. J. Gilman, J. B. Lord, D. Winokur, S. Springer, D. Irimia, S. Nagrath, L. V. Sequist, R. J. Lee, K., J. Isselbacher, S. Maheswaran, D. A. Haber and M. Toner, Proceedings of the National Academy of Sciences of the United States of America, 2010, 107, 18392-18397.
13. R. E. Rosensweig, Ferrohydrodynamics, Cambridge University Press, Cambridge, 1985.
14. W. Zhao, T. Zhu, R. Cheng, Y. Liu, J. He, H. Qiu, L. Wang, T. Nagy, T. D. Querec, E. R. Unger and L. Mao, Adv Funct Mater, 2016, 26, 3990-3998.
15. Y. N. Xia and G. M. Whitesides, Annu Rev Mater Sci, 1998, 28, 153-184.
16. R. Massart, Ieee T Magn, 1981, 17, 1247-1248.

### Example 2

Circulating tumor cells (CTCs) have significant implications in both basic cancer research and clinical applications. To address the limited availability of viable CTCs for fundamental and clinical investigations, effective separation of extremely rare CTCs from blood is critical. Ferrohydrodynamic cell separation (FCS), a label-free method that conducted cell sorting based on cell size difference in biocompatible ferrofluids, has thus far not been able to enrich low-concentration CTCs from cancer patients' blood because of technical challenges associated with processing clinical samples. In the present disclosure, we demonstrate the development of a laminar-flow microfluidic FCS device that was capable of enriching rare CTCs from patients' blood in a biocompatible manner with a high throughput (6 mL h⁻¹) and a high rate of recovery (92.9%). Systematic optimization of the FCS devices through a validated analytical model was performed to determine optimal magnetic field and its gradient, ferrofluid properties, and cell throughput that could process clinically relevant amount of blood. We first validated the capability of the FCS devices by successfully separating low-concentration (˜100 cells mL⁻¹) cancer cells using six cultured cell lines from undiluted white blood cells (WBCs), with an average 92.9% cancer cell recovery rate and an average 11.7% purity of separated cancer cells, at a throughput of 6 mL per hour. Specifically, at ˜100 cancer cell mL⁻¹ spike ratio, the recovery rates of cancer cells were 92.3±3.6% (H1299 lung cancer), 88.3±5.5% (A549 lung cancer), 93.7±5.5% (H3122 lung cancer), 95.3±6.0% (PC-3 prostate cancer), 94.7±4.0% (MCF-7 breast cancer), and 93.0±5.3% (HCC1806 breast cancer), and the corresponding purities of separated cancer cells were 11.1%±1.2% (H1299 lung cancer), 10.1±1.7% (A549 lung cancer), 12.1±2.1% (H3122 lung cancer), 12.8±1.6% (PC-3 prostate cancer), 11.9±1.8% (MCF-7 breast cancer), and 12.2±1.6% (HCC1806 breast cancer) Biocompatibility study on H1299 cell line and HCC1806 cell line showed that separated cancer cells had excellent short-term viability, normal proliferation and unaffected key biomarker expressions. We then demonstrated the enrichment of CTCs in blood samples obtained from two patients with newly diagnosed advanced non-small cell lung cancer (NSCLC). While still at its early stage of development, FCS could become a complementary tool for CTC separation for its high recovery rate and excellent biocompatibility, as well as its potential for further optimization and integration with other separation methods.

### Introduction

Circulating tumor cells (CTCs) are cancer cells that are detached from primary solid tumors and carried through the vasculature to potentially seed distant site metastases in vital organs the main cause of death by cancer.^{1, 2} Molecular assessments of CTCs not only could benefit basic cancer research, but also night eventually lead to a more effective cancer treatment.^{3, 5} However, one major limitation of CTCs in cancer research and its clinical applications has been the limited availability of viable CTCs for investigations, due in part to the small patient blood volumes that are allowable for research, which usually yielded less than 100 CTCs from 1 mL of whole blood.⁵⁻⁷ As a result, technologies are needed in order to separate these rare cells from blood, and important performance criteria for these technologies include the ability to process a significant amount of blood quickly (e.g., throughput ˜7.5 mL h⁻¹), a high recovery rate of CTCs, a reasonable purity of isolated cancer cells, and cell integrity for further characterization.⁸

CTCs represent the composition of the primary tumor, including the heterogeneity of tumors.^{5, 9} While CTCs initially express same biological or physical markers as the primary tumor epithelial cells, once in circulation they may undergo morphological and gene expression changes, which could determine what distant site will become the new niche for a metastatic tumor. Enriching the whole CTC population, instead of just the ones responding to specific biological or physical markers, can allow basic investigations such as CTC heterogeneity, and may lead to a more precise prognosis of undetected metastasis and recurrence risk for cancer patients.¹⁰ Label-based CTC separation technologies were developed to selectively enrich a subset of CTCs from blood, primarily through the use of specific biological markers including epithelial cell adhesion molecule (EpCAM).¹¹⁻¹³ These antigen-based labels were a rate-limiting factor in effective CTC separation, as the inherent heterogeneity of CTCs might render these technologies ineffective for general use. The vast array of various biomarkers that might or might not be expressed, and which could not be predicted to remain expressed in CTCs undergoing Epithelial-to-Mesenchymal Transitions (EMT) would be cumbersome and confounding in these label-based methods. Furthermore, most label-based technologies did not conveniently enable comprehensive molecular analysis of separated CTCs because they were either dead or immobilized to a surface.¹⁴ On the other hand, a variety of label-free methods including those based on filtration,¹⁵ acoustophoresis,¹⁶ dielectrophoresis,¹⁷⁻¹⁹ dean flow,²⁰⁻²² and vortex technology²³⁻²⁵ were developed recently to exploit specific physical markers in order to deplete non-CTCs in blood therefore enrich cancer cells. They were not affected by the heterogeneity of biological marker expressions and could permit enrichment of nearly all CTCs that were above a predetermined threshold of a physical marker, for example, the size of CTCs. Most CTCs of epithelial origin have a size range between 15 μm and 25 μm, and are larger than red blood cells (RBCs, 6-9 μm), and the majority of white blood cells (WBCs, 8-14 μm).⁸ However, CTCs of smaller sizes were found in blood circulation.^{26, 27} The existence of large WBCs such as monocytes that may have overlapping sizes with CTCs could further complicate label-free separation methods.^{7, 14, 28} Both label-based and label-free methods had their limitations; more sophisticated strategies including novel sorting methods such as acoustophoresis¹⁶ and vortex technology²³⁻²⁵, or a combination of two or more methods to enrich rare cells based on multiple biological or physical markers could potentially improve the overall performance of CTC separation.²⁹⁻³³ One successful device is the CTC-iChip that integrated both label-based and label-free separation methods. This device first used deterministic lateral displacement to deplete smaller RBCs from patient blood based on their size, then applied inertial force to focus remaining cells into a narrow stream, and eventually separated WBCs that were coated with anti-CD45 and anti CD66b magnetic beads from CTCs for a high-throughput and high-recovery separation.^{29, 30} While each of these three methods alone might have its own limitation in rare cell separation, their integration were critical to the overall success of CTC-iChip. There is a need to develop new and high-performance CTC separation method that not only performs well on its own, but also can be easily integrated with other methods to achieve high-throughput, high-recovery, high-purity separation of intact CTCs. A frequently used method in CTC or rare cell separation was functionalizing magnetic particles to target and pull cells of interest through magnetic force or “magnetophoresis” towards a magnetic field maxima, as illustrated in FIG. 7A. Magnetophoresis, when used for CTC separation, has achieved high-throughput and high-specificity isolation of cancer cells from blood.^{13, 34-41} On the other hand, it is a label-based method and requires time-consuming and laborious sample preparation.

In this paper, we reported a new ferrohydrodynamic cell separation (FCS) method that still used magnetic buoyance force for size-based CTC separation, but was label-free, biocompatible and enriched rare CTCs from patient blood with a high throughput and a high rate of recovery. We demonstrated that FCS could separate a variety of low-concentration cancer cells of cell culture lines from RBC-lysed blood at a throughput of 6 mL h⁻¹, with an average cancer cell recovery rate of 92.9% and an average cancer cell purity of 11.7% after separation. CTCs were successfully enriched from blood samples of two non-small cell lung cancer (NSCLC) patients using FCS devices. We envision that FCS could offer the potential to serve as a complementary tool in CTC separation because of its excellent biocompatibility and label-free operation. FCS could also be integrated with other separation methods such as magnetophoresis for a more comprehensive isolation of rare cells. The working principle of ferrohydrodynamic cell separation is “negative magnetophoresis” in biocompatible ferrofluids, as illustrated in FIG. 7B.⁴² Cells including CTCs and WBCs immersed inside an uniformly magnetic media (ferrofluids) can be considered as “magnetic holes”.⁴³ A non-uniform magnetic field gradient induces an imaginary dipole moment in these “magnetic holes”, and generates a size-dependent magnetic body force, also referred to as magnetic buoyancy force that pushes the cells away to a magnetic field minima.⁴⁴ Forces on the cells can therefore sort them based on their size difference in a continuous ferrofluid flow. In practice, a mixture of RBC-lysed blood and ferrofluids was injected into the inlet A of a FCS device such as the one shown in FIG. 7C. Cells in blood were filtered then focused by a sheath flow from inlet B. After entering the channel region that was on top of a permanent magnet, large cells including CTCs and some WBCs experienced more size-dependent magnetic buoyance force than smaller WBCs, resulting in a spatial separation between them at the outlets of the device. Although ferrohydrodynamic cell separation was demonstrated before,⁴⁵⁻⁴⁹ its application in CTCs was challenging in the past for the following reasons. First, rarity of CTC necessitates a blood-processing throughput of close to 7.5 mL h⁻¹ and recovery rate of at least 80% in low concentration (<100 cell mL⁻¹ ) conditions.⁸ Previous applications of ferrohydrodynamic cell separation mostly focused on sorting of bacteria and yeast cells,^{45, 46} bacteria and red blood cells,⁴⁷ and cancer cells of cultured cell lines from blood.^{48, 49} The throughputs of these studies were lower than what was required of CTC separation, and the target cells were mostly spiked at a much higher concentration (e.g., 10⁵-10⁶ cells mL⁻¹ ) than CTCs.⁴⁵⁻⁴⁸ Second, ferrofluids, as a colloidal suspension of magnetic nanoparticles with diameters of approximately 10 nm, need to be rendered biocompatible for CTC separation. Cancer cells should remain alive and their normal functions should be kept intact during and after the separation for post-separation characterization. It is therefore critical to systematically optimize FCS and ferrofluid design so that the throughput and recovery rate of separation are comparable to those needed for CTC separation, and the separated cells are viable and their normal functions are intact.

We overcame these challenges associated with ferrohydrodynamic cell sorting of CTCs, and demonstrated a 92.9% recovery rate and an 11.7% purity of low-concentration (˜100 cells mL⁻¹) cancer cells with a blood-processing throughput of 6 mL of blood per hour, and validated the technology using blood from NSCLC patients. We performed systematic parametric studies of key factors influencing the performance of FCS and determined parameters for high-throughput, high recovery rate and biocompatible CTC separation. We then tested and validated the performance of the method with cancer cells from 6 cultured cancer cell lines and 3 different types of cancer. The mean recovery rate of cancer cells from RBC-lysed blood using this technology is 92.9%, a value much better than currently reported an average of 82%.⁸ Separated cancer cells had excellent short-term viability, unaffected biological marker expressions, and intact capability to proliferate to confluence. Finally, we applied the FCS method to successfully enrich CFCs from blood samples of two stage IVB NSCLC patients, and discussed the advantages and limitations of this method and potential ways to improve.

### Experimental Section

Modeling of FCS and its calibration. The model used in this example to simulate cell trajectories in three-dimensional (3D) manner was previously described.^{50, 51} We modified the analytical model for the present example, which could predict the 3D transport of diamagnetic cancer cells and. WBCs in ferrofluids inside a microfluidic channel coupled with permanent magnets. The magnets produced a spatially non-uniform magnetic field that led to a magnetic buoyancy force on the cells. Trajectories of the cells in the device were obtained by (1) calculating the 3D magnetic buoyancy force via an experimentally verified and analytical distribution of magnetic fields as well as their gradients, together with a nonlinear Langevin magnetization model of the ferrofluid, (2) deriving the hydrodynamic viscous drag force with an velocity profile of the channel obtained from COMSOL Multiphysics (Version 3.5, COMSOL Inc., Burlington, Mass.), (3) solving governing equations of motion using analytical expressions of magnetic buoyancy force and hydrodynamic viscous drag force in MATLAB (MathWorks Inc., Natick, Mass.). The parameters of simulation (device dimension and geometry, fluid and cell properties, and magnetic fields) reflected exact experimental conditions.

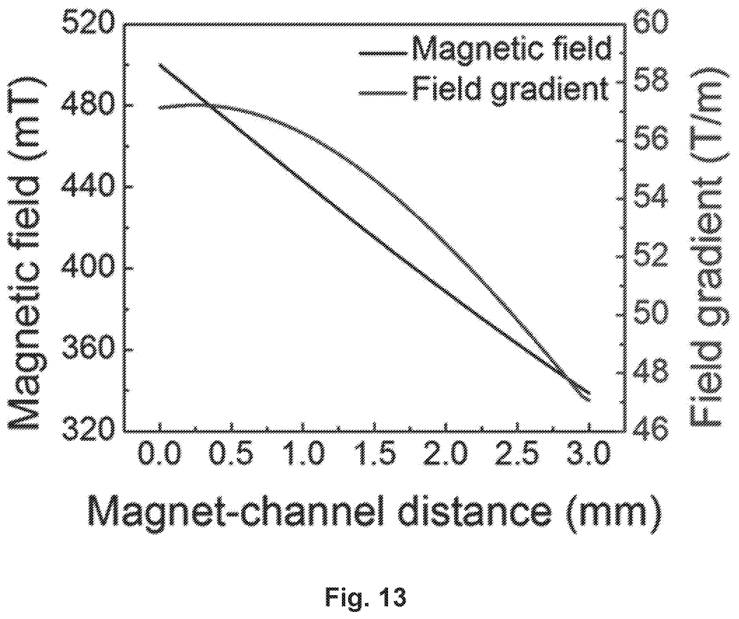

Polystyrene microparticles (Polysciences, Inc., Warminster, Pa.) with diameters of 15.7 μm were mixed together with WBCs at the concentration of 1×10⁴ particles mL⁻¹ for model calibration. Microparticle and cell mixtures were injected into inlet A of a FCS device with a flow rate of 1.2-6 mL h⁻¹. The flow rate of inlet B was fixed at 6 mL h⁻¹ for all experiments. The magnet was placed 1 mm away from the channel, which corresponded to magnetic field strengths 443 mT and magnetic field gradients 56.2 T m⁻¹ (FIG. 13). A ferrofluid with a concentration of 0.26% (v/v) were used in calibration experiments.

Custom-made biocompatible ferrofluids. A water-based ferrofluid with maghemite nanoparticle was synthesized by a chemical co-precipitation method and made biocompatible following a protocol previously described.^{48, 49} Details of the ferrofluid synthesis and fractionalization are described in detail below. Size and morphology of the maghemite nanoparticles were characterized via transmission electron microscopy (TEM; FEI Corp., Eindhoven, the Netherlands). Magnetic properties of the resulting biocompatible ferrofluid were measured at room temperature using a vibrating sample magnetometer (VSM; MicroSense, LLC, Lowell, Mass.). Briefly, particle size distribution of the custom-made ferrofluid was 1025±2.96 nm. Saturation magnetization of the as-synthesized ferrofluid was 0.96 kA m⁻¹, corresponding to an estimated 0.26% volume fraction of magnetic content. This ferrofluid was colloidally stable for up to 10 months' storage, did not show particle agglomeration during microfluidic operations, and was made to be isotonic and have a 7.0 pH and neutral surfactant for biocompatible cell separation.

Cell culture and sample preparation. Six cancer cell lines (ATCC, Manassas, Va.) including three lung cancer cell lines (H1299, A549 and H3122), one prostate cancer cell line (PC-3), and two breast cancer cell lines (MCF-7 and HCC1806) were used in this study. H1299, A549, H3122, PC-3, and HCC1806 cells were cultured in RPMI-1640 medium (Mediatech, Inc., Manassas, Va.) supplemented with 10% (v/v) fetal bovine serum (FBS; Life Technologies, Carlsbad, Calif.) and 1% (v/v) penicillin/streptomycin solution (Mediatech, Inc., Manassas, Va.). MCF-7 cells were cultured in Dulbecco's modified eagle medium (DMEM; Life Technologies, Carlsbad, Calif.) supplemented with 10% (v/v) FBS, 1% (v/v) penicillin/streptomycin solution and 0.1 mm MEM non-essential amino acid (NEAR; Life Technologies, Carlsbad, Calif.). All cell cultures were maintained at 37° C. under a humidified atmosphere of 5% CO₂. Cell lines were released through incubation with 0.05% Trypsin-EDTA solution (Life Technologies, Carlsbad, Calif.) at 37° C. for 5-10 minutes before each use.

Cancer cells were fluorescently stained by incubation with 2 μm CellTracker Green (Life Technologies, Carlsbad, Calif.) for 30 minutes before each use. Probe solution was replaced with culture medium by centrifuging at 200×g for 5 minutes. Cells were counted with a hemocytometer (Hausser Scientific, Horsham, Pa.) and serially diluted in culture medium to achieve a solution with approximately 1×10⁴ cells per mL. Cells were then counted with a Nageotte counting chamber (Hausser Scientific, Horsham, Pa.) to determine the exact number of cells per μL. Desired number of cancer cells (50, 100, 200, 500, 1000, or 2000) were spiked into 1 mL of WBCs (RBC-lysed whole blood). The number of cancer cells spiked was determined by the average of two counts, with an average of 5.2% difference between the counts. We chose to focus on separating cancer cells from WBCs because of the size of WBCs (8-14 μm) were much closer to cancer cells (15-25 μm) than RBCs (6-9 μm). Human whole blood from healthy subjects (Zen-Bio, Research Triangle Park, N.C.) was lysed by RBC lysis buffer (eBioscience, San Diego, Calif.) with a volume ratio of 1:10 for 5 minutes at room temperature. Cell mixtures were centrifuged at 800×g for 5 minutes and the pellet was suspended in the same volume of ferrofluid containing 0.1% (v/v) Pluronic F-68 non-ionic surfactant (Thermo Fisher Scientific, Waltham, Mass.). WBCs were fixed by 4% (% v) paraformaldehyde (PFA; Santa Cruz Biotechnology, Dallas, Tex.) at 4° C. for 30 minutes for long-term use.

Biocompatibility study of FCS. Short-term cell viability after FCS was examined using a Live/Dead assay (Life Technologies, Carlsbad, Calif.). 1×10⁶ H1299 cancer cells suspended in 1 mL of ferrofluids were injected into inlet A of a FCS device at a flow rate of 6 mL h⁻¹. After separation, cells from outlet 6 were collected and washed with phosphate buffered saline (PBS; Life Technologies, Carlsbad, Calif.) three times. Cells were then incubated with working solution (2 μM calcein-AM and 4 μM ethidium homodimer-1 (EthD-1)) for 30 minutes at room temperature. After the solution was removed and washed with PBS, labeled cells were observed under a fluorescence microscope (Carl Zeiss, Germany) for counting. For long-term proliferation, separated. H1299 cells from a FCS device were collected into a centrifuge tube and washed three times with culture medium to remove the nanoparticles, and then the cells were suspended in culture medium and seeded into a 24-well plate (Corning Inc., Corning, N.Y.). Cells were then cultured at 37° C. under a humidified atmosphere of 5% CO₂, the medium was refreshed every 24 h during the first 3 days. Cellular morphology was inspected every 24 hours.

Surface biomarker expression change was studied by immunofluorescence staining of cancer cells with EpCAM and cytokeratin antibodies. HCC1806 cancer cells were collected after FCS and seeded on a coverslip. After 24-h incubation, cells were fixed with 4% (w/v) PFA for 30 minutes and subsequently permeabilized with 0.2% (v/v) Triton X-100 (Sigma-Aldrich, St. Louis, Mo.) in PBS for 10 minutes. Cells were then blocked by 0.5% (w/v) bovine serum albumin (BSA; Miltenyi Biotec, San Diego, Calif.) in PBS for 20 minutes. After blocking nonspecific binding sites, cells were immunostained with primary antibodies, anti-cytokeratin 8/18/19 (Abeam, Cambridge, Mass.), human EpCAM/TROP-1 (R&D System, Minneapolis, Minn.). Appropriately matched secondary Alexa Fluor-conjugated antibodies (Life Technologies, Carlsbad, Calif.) were used to identify cells. Nuclei were stained with 4′,6-Diamidino-2-Phenylindole (DAPI; Life Technologies, Carlsbad, Calif.). After immunofluorescence staining, cells were washed with PBS and stored at 4° C. or imaged with a fluorescence microscope.

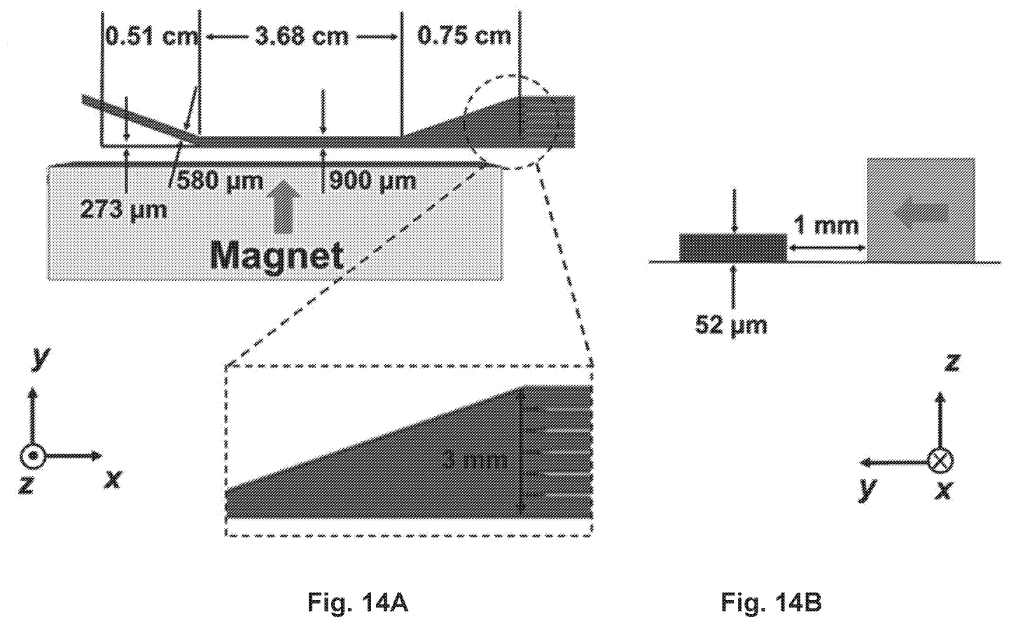

FCS device fabrication and cell separation. Microfluidic devices were made of polydimethylsiloxane (PDMS) using standard soft lithography techniques. The thickness of the microfluidic channel was measured to be 52 μm by a profilometer (Veeco Instruments, Chadds Ford, Pa.). One NdFeB permanent magnet (K&J Magnetics, Pipersville, Pa.) was embedded into the PDMS channel with their magnetization direction vertical to the channel during the curing stage. The magnet is 5.08 cm in length, 1.27 cm in both width and thickness. Flux density at the center of magnet's surface was measured to be 0.5 T by a Gauss meter (Sypris, Orlando, Fla.) and an axial probe with 0.381 mm diameter of circular active area. Detailed geometries of device setup can be found in FIGS. 14A-B. Fabricated devices were first flushed by 70% ethanol for 10 minutes at the flow rate of 6 mL h⁻¹ and then primed with 1×PBS supplemented with 0.5% (w/v) BSA and 2 mM EDTA (Thermo Fisher Scientific, Waltham, Mass.) for 10 minutes at the flow rate of 6 mL h⁻¹ before each use.²²

During a typical experiment, a microfluidic device was placed on the stage of an inverted microscope (Carl Zeiss, Germany) for observation and recording. Two fluid inputs were controlled by individual syringe pumps (Chemyx, Stafford, Tex.) at tunable flow rates. Blood samples were injected into inlet A of a FCS device, sheath flow (ferrofluids) was injected into inlet B. Images and videos of microparticles and cells were recorded with a high-resolution CCD camera (Carl Zeiss, Germany). After separation, cells were collected in a serpentine collection chamber for cell counting.

NSCLC Patient blood processing. De-identified blood samples were obtained from newly diagnosed advanced NSCLC patients before treatment with informed consents according to a protocol approved by Institutional Review Board (IRB) at Augusta University. All blood samples were collected into vacutainer tubes (BD, Franklin Lakes, N.J.) containing the anticoagulant K₂EDTA and were processed within 3 hours of blood draw. In a typical process, every 1 mL of whole blood was lysed by 10 mL of RBC lysis buffer for 5 minutes at room temperature. WBCs were then collected by spinning down the solution at 800×g for 5 minutes and the pellet was suspended in 1 mL of ferrofluid containing 0.1% (v/v) Pluronic F-68. The sample was then loaded into a 10-mL syringe (BD, Franklin Lakes, N.J.) followed by processing with the FCS device at a flow rate of 6 mL A stainless-steel sphere (BC Precision, Chattanooga, Tenn.) with a diameter of 1.6 mm was also loaded into a syringe. A magnet was used to gently agitate the sphere to prevent blood cells from settling down every 5-10 minutes. After separation, the FCS device was flushed by PBS or ThinPrep PreservCyt solution (Hologic, Marlborough, Mass.) at 30 mL h⁻for 20 minutes to remove any cells in outlet reservoir. During the separation, the cells from outlet 6 of a FCS device were directly preserved in ThinPrep PreservCyt solution for further analysis.

CTC identification. After processing of blood with a FCS device, collected cells were preserved in ThinPrep PreservCyt solution. Samples collected in ThinPrep vials were directly loaded into ThinPrep 2000 processor (Hologic, Marlborough, Mass.), which is an automated slide-processing instrument that was routinely used in cytology laboratory for preparing gynecologic and non-gynecologic samples. The instrument transferred diagnostic cells in the sample to a slide that was then immersed in cell fixative bath ready for staining. Papanicolaou (Pap) staining of the slides was performed using Shandon Gemini stainer (Thermo Fisher Scientific, Waltham, Mass.) followed by cover-slipping using permount. ThinPrep slides were afterwards evaluated by a cytopathologist using light microscopy to identify and count the number of CTCs. Collected cells were also fixed with 4% (w/v) PFA for 30 minutes and subsequently permeabilized with 0.2% (v/v) Triton X-100 in PBS for 10 minutes. Cells were then blocked by 0.5% (w/v) BSA in PBS for 20 minutes. After blocking nonspecific binding sites, cells were immunostained with primary antibodies, anti-cytokeratin 8/18/19, human EpCAM/TROP-1, and anti-CID45 (Abeam, Cambridge, Mass.). Following, the appropriately matched secondary Alexa Fluor-conjugated antibodies (Life Technologies, Carlsbad, Calif.) were used to identify cells. After immunofluorescence staining, cells were washed with PBS and stored at 4° C. or imaged with a fluorescence microscope.

### Results and Discussion

### Optimization of FCS for High-Throughput, High-Recovery and Biocompatible CTC Separation

Previous ferrohydrodynamic cell sorting devices were developed to process cells at low throughput and high spike ratios,^{45, 47-49} therefore cannot be realistically used to separate CTCs from blood. CTCs are extremely rare in the blood circulation, occurring usually at a concentration of less than 100 CTCs per mL of blood.⁵⁻⁷ These cells are dispersed in a background of billions of RBCS and millions of WBCs, making the separation of CTCs a significant challenge. For any CTC separation method, it is necessary for it to be able to process several milliliters of blood within one hour with a high CTC recovery rate to enrich sufficient numbers of viable CTCs. Thus, high-throughput, high recovery rate, reasonable purity and biocompatible separation of viable CTCs are four criteria for any separation method targeting clinical applications. For ferrohydrodynamic cell separation (FCS) method, the parameters that will affect the above-mentioned criteria include device geometry, magnetic field and its gradient, flow rate of cells, and ferrofluid properties (i.e., magnetic volume fraction or concentration, pH, tonicity, materials and surfactants of nanoparticles, colloidal stability). These parameters are highly coupled with each other and for this reason an effective model was needed for systematic device optimization. To search for parameters for high-throughput, high recovery rate, reasonable purity and biocompatible CTC separation, we first started with a device geometry depicted in FIG. 7D and FIGS. 14A-B that operated in low Reynolds number laminar flow region when its cell flow rates were from 1.2 to 7.2 mL h⁻¹. The corresponding Reynolds numbers were from 0.5 to 3.1, and the upper limit of this flow rate range was close to the clinically relevant throughput in typical CTC separation. We then created an analytical model that could predict three-dimensional (3D) trajectories of cancer cells and blood cells in ferrofluids inside this device coupled with a permanent magnet. We considered both magnetic buoyancy force and hydrodynamic drag force in simulating the cell trajectories. The detailed description of this 3D analytical model is described below.

The dominant magnetic force in ferrohydrodynamic cell sorting (FCS) is a magnetic buoyancy force generated on diamagnetic cells immersed in ferrofluids. Particles immersed in ferrofluids experience this force under a non-uniform magnetic field,⁴⁴

\vec{F}ₘ=μ₀V_{c}[(\vec{M}_{c}−\vec{M}_{f})·∇]\vec{H} (1)

where μ₀=4π×10⁻⁷ H m⁻¹ is the permeability of free space, V_{c} is the volume of the magnetized body, in this case a cell, \vec{M}_{c} is its magnetization (close to zero for most cells), \vec{M}_{f} is magnetization of the ferrofluid surrounding the body, and \vec{H} is magnetic field strength at the center of the body.⁴⁴ For cell separation in ferrofluids under a strong magnetic field, magnetization of the ferrofluid with superparamagnetic particles in it can be modeled via Langevin function,⁴⁴

$$\frac{{\vec{M}}_{f}}{{φ}_{f} {\vec{M}}_{f , b}} = L ( {α}_{f} ) = coth ( {α}_{f} ) - \frac{1}{{α}_{f}} \qquad ( 2 )$$

where α_{f}=μ₀πM_{f,b}Hd³_{f}/6κ_{B}^{T}, ϕ_{f} is the volume fraction of the magnetic materials in ferrofluids,⁴⁴ M_{f,b} is saturation moment of the bulk magnetic materials, and d_{f} is the diameter of nanopartides in a ferrofluid. κ_{B} is the Boltzmann constant, T is temperature. In ferrohydrodynamic cell sorting, the magnetization of the cell \vec{M}ₚ is less than its surrounding magnetic liquid \vec{M}_{f}, and the direction of the magnetic force \vec{F}ₘ on the cell is pointing towards magnetic field minima.

The hydrodynamic viscous drag force exerted on diamagnetic cell takes the form,

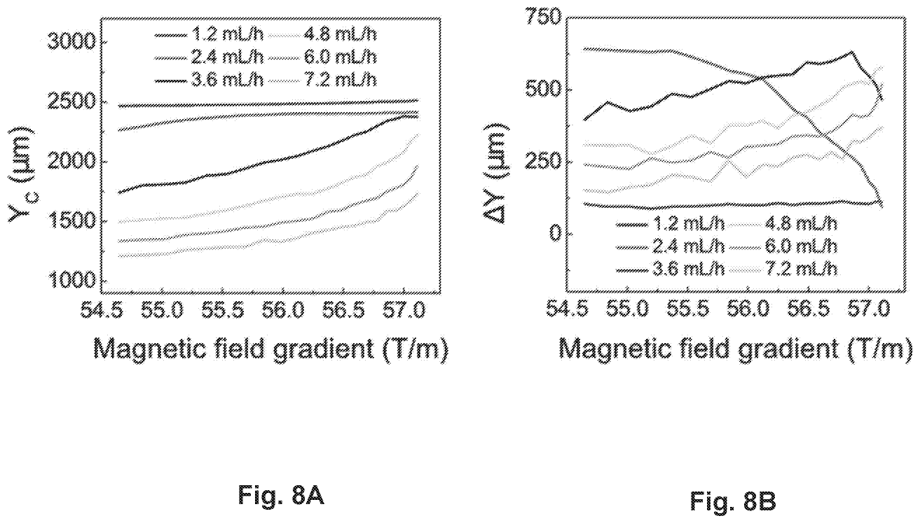

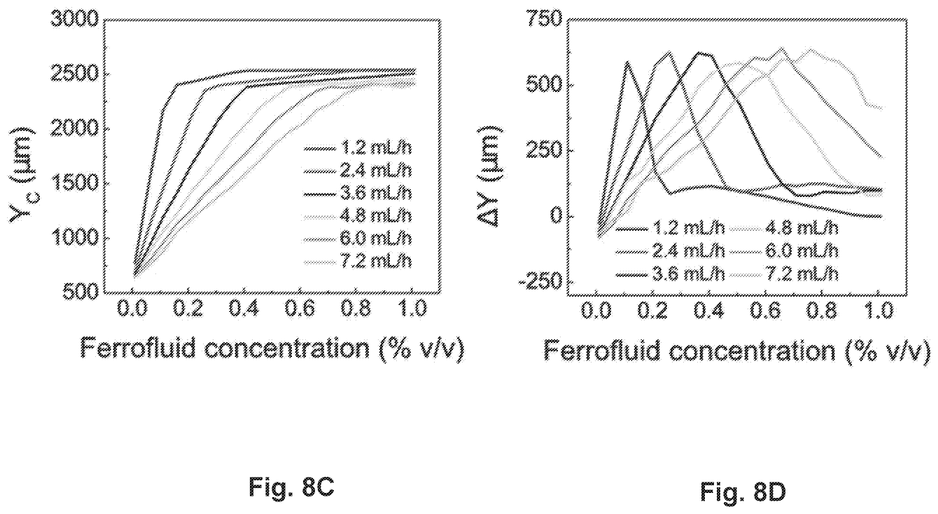

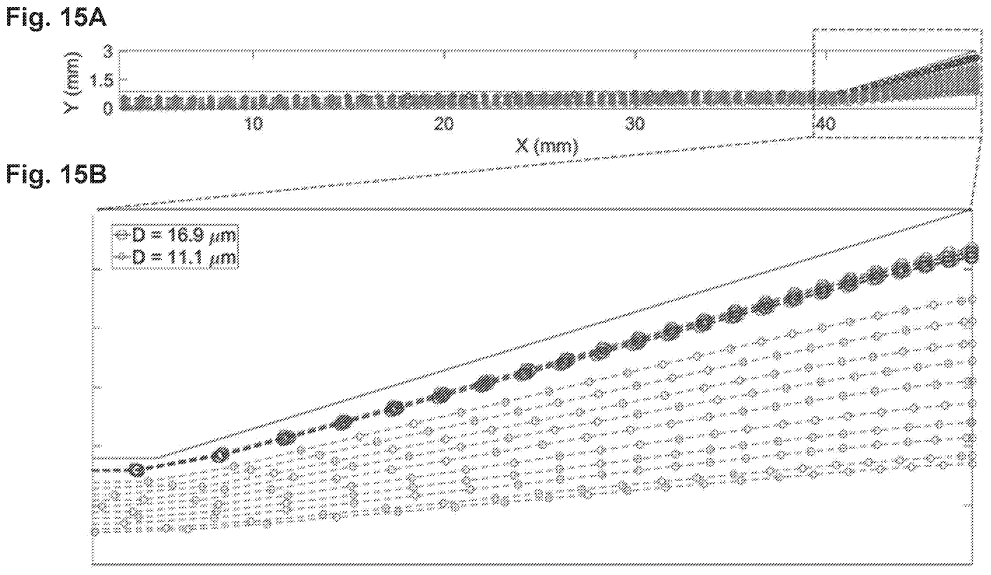

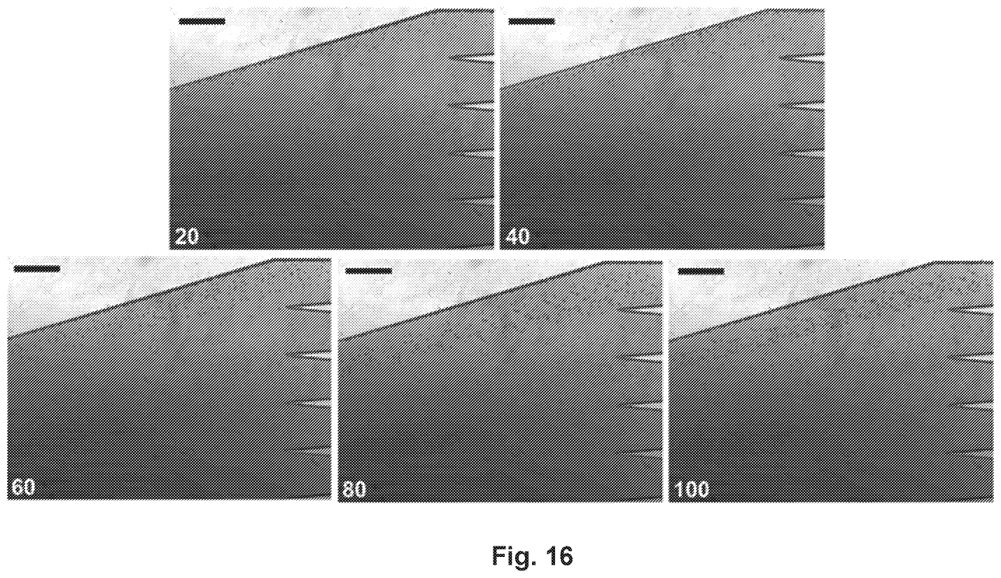

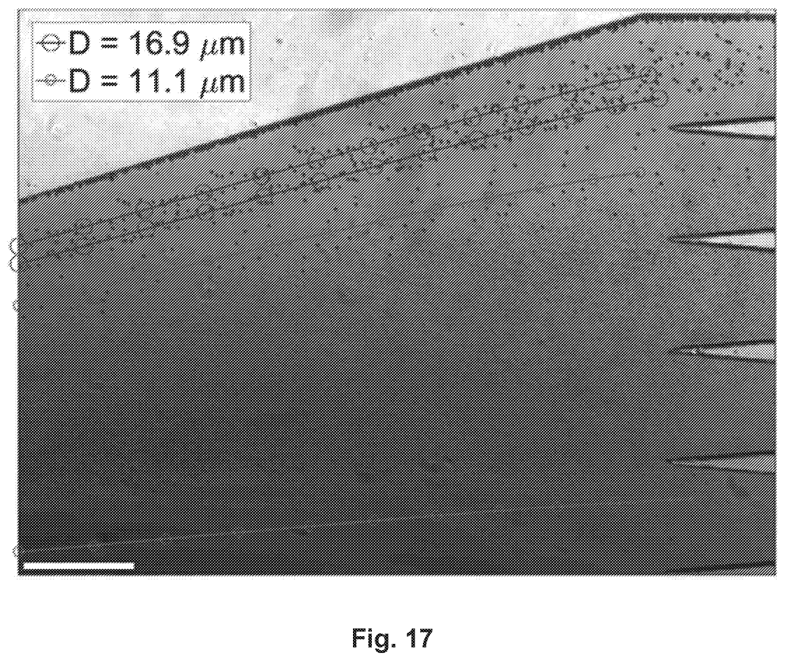

\vec{F}_{d}=−3πηD_{c}(\vec{U}_{c}−\vec{U}_{f})f_{D} (3)

where η is the viscosity of ferrofluids, D_{c} is the diameter of the cell, \vec{U}_{c} and \vec{U}_{f} and are the velocity vectors of the cell and ferrofluids respectively, f_{D} is the hydrodynamic drag force coefficient for a cell moving near a solid surface, often referred to as the “wall effect”.⁵²⁻⁵⁴ Because of the low Reynolds number in FCS devices, inertial effects on the cell were neglected and motion of cells in ferrofluids could be determined by the balance of hydrodynamic viscous drag force and magnetic buoyancy force. From Equations 1-3, it can be seen that cells with different volumes experience different magnitudes of magnetic buoyancy force, which can result in the separation of these cells in ferrofluids in a continuous-flow manner. We first confirmed the validity of the model by comparing simulated trajectories (FIG. 15A-B) with experimental ones (FIG. 16) that were obtained from imaging 15.6-μm-diameter polystyrene beads and 11.1-μm-diameter WBCs in a FCS device, as shown in FIG. 17. We then used the model to optimize the FCS device for CTC separation. The optimization was focused on the study of separating cancer cells from WBCs, because of their subtle size difference. Briefly, we allowed cancer cells and WBCs (H1299 lung cancer cells with a mean diameter of 16.9 μm, and WBCs with a mean diameter of 11.1 μm) to enter the channel and simulated their trajectories in ferrofluids under external magnetic fields. From their simulated trajectories, we calculated two outputs a deflection in the y-direction (see FIG. 1 and FIG. 14A-B for coordinates) for cancer cells, denoted as Y_{C}, and a separation distance between the two types of cells, denoted as ΔY (FIG. 15A-B). Both outputs were optimized using parameters including flow rates of cell inlet (1.2-7.2 mL h⁻¹), magnetic fields and gradients (field: 471-415 mT; gradient: 57.1-54.6 T m⁻¹, as shown in FIG. 13), and ferrofluid concentrations (up to 1% v/v). The goal here was to achieve high cell flow rate, cancer cell recovery rate and recovered cancer cell purity, which translated to maximizing both Y_{C} and ΔY simultaneously. FIG. 8A shows when the magnetic field gradient increased, the deflection distance of cancer cells Y_{C} increased monotonically for all flow rates. This was because the driving force, magnetic buoyancy force on cells, was proportional to the magnitude of magnetic field gradient. As the cell inlet flow rate increased, Y_{C} decreases due to reduced time in the channel. FIG. 8B shows similar trend of separation distance ΔY increasing as the field gradient increased when flow rates are 4.8, 6.0 and 7.2 mL h⁻¹. Interestingly, when cell input flow rates are smaller (e.g., 1.2, 2.4 and 3.6 mL h⁻¹), the separation distance ΔY between two cell types had different trends. This was due to the fact that both cell types at slower flow rates reached their maximum deflections very quickly, resulting in a mixing rather than separation of the two types. For practical CTC separation, we chose a cell flow rate of 6 mL h⁻¹ and a magnetic field gradient of 56.2 T m⁻¹ that could be generated realistically through magnet and channel integration in a FCS device to achieve high-throughput and high recovery rate cell separation. It should be noted here that the optimization was conducted on a single-channel device, and higher cell flow rates and throughputs were possible with device scale-up or multiplexing.

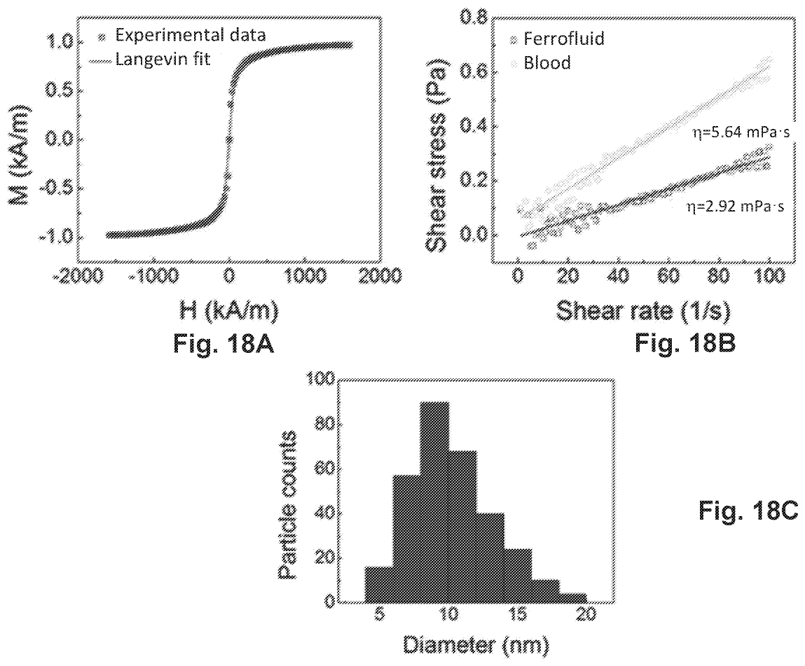

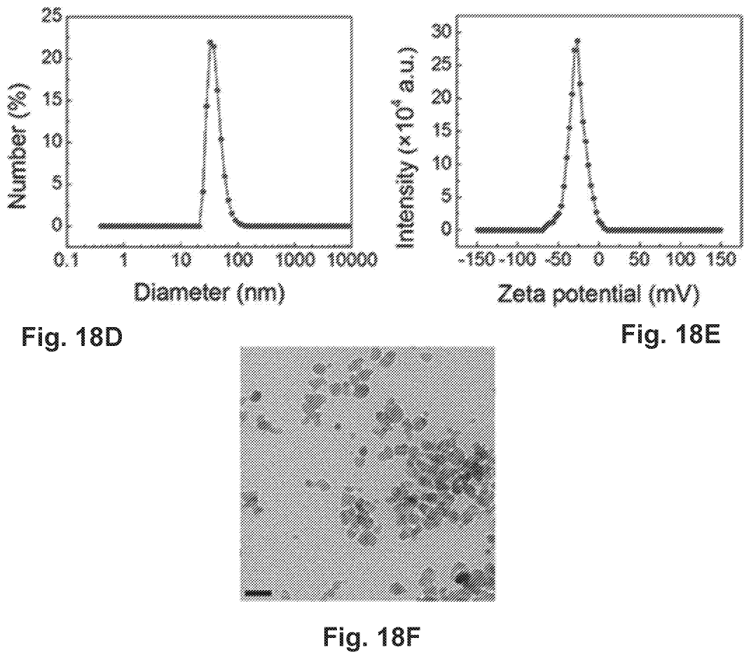

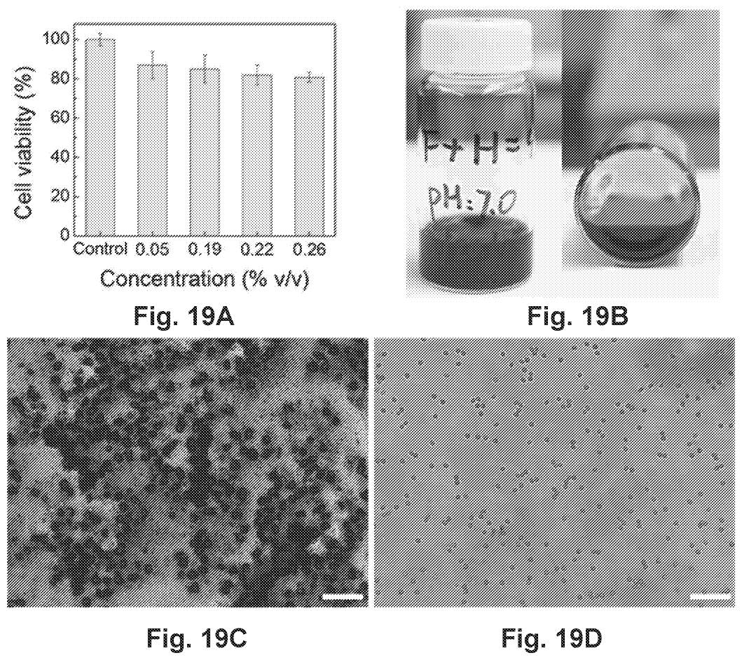

After optimizing flow rate and magnetic field gradient, another critical parameter that still needs to be optimized is the ferrofluid itself. Ideally, the ferrofluid needs to possess properties that are not only biocompatible to CTCs but also enable its colloidal stability under high flow rates and strong magnetic fields. Therefore, its pH value, tonicity, materials and surfactants of nanoparticles need to be optimized as a biocompatible medium for cells, while at the same time the overall colloidal stability of the ferrofluid will have to be well maintained. Based on our previous work,^{48, 49} we have developed a water-based ferrofluid with maghemite nanoparticles in it that was tested to be biocompatible for cancer cells from cultured cells lines. The particles had a mean diameter of 11.24 nm with a standard deviation of 2.52 nm (FIG. 18A-F). The diameter of the nanoparticles was chosen to preserve the colloidal stability of ferrofluids against agglomeration due to gravitational settling and magnetic dipole-dipole attraction. As a result, our ferrofluids remained colloidally stable after at least 10 months' storage (FIG. 19A-D). The nanoparticles were functionalized with a graft copolymer as surfactants to prevent them from coming too close to one another when there was a magnetic field. The volume fraction of the magnetic content of the ferrofluid is 0.26%. This low volume fraction of the ferrofluid not only leaded to excellent biocompatibility for cell sorting, but also enabled us to observe cell motion in microchannel directly with bright-field microscopy, which was difficult with opaque ferrofluids of high solid volume fractions. The ferrofluid was made to be isotonic and its pH was adjusted to 7.0 for biocompatible cell separation. The outcomes of ferrofluid characterization are listed in FIG. 18A-F. We further optimized the ferrofluid concentration for high-throughput and high recovery separation. From Equation 1, the magnetic buoyancy force depends on the magnetization of the ferrofluid and affects the cell separation outcome. Therefore, the concentration of ferrofluid had an impact on the process of cell separation. A higher concentration could lead to a higher magnitude of magnetic buoyancy force on cells and a larger deflection Y_{C} (FIG. 8C), but not necessarily a larger ΔY (FIG. 8D). FIG. 8D shows there was an optimal ferrofluid concentration close to 0.6% (v/v) at 6.0 mL h⁻¹ flow rate for ΔY. Concentrations higher than 0.6% (v/v) resulted in larger Y_{C} but smaller ΔY. This again was because both cell types achieved sufficient deflections in a strongly magnetized ferrofluid, resulting in mixing rather than separation of the two. In addition, ferrofluid biocompatibility could be compromised as its nanoparticle concentration increases.⁴⁹ Based on these considerations, we chose a 0.26% (v/v) ferrofluid concentration to strike a balance between high-recovery and biocompatible cell separation at a flow rate of 6 mL h⁻¹.

### Verification of FCS for High-Throughput and High-Recovery Spiked Cancer Cells Separation

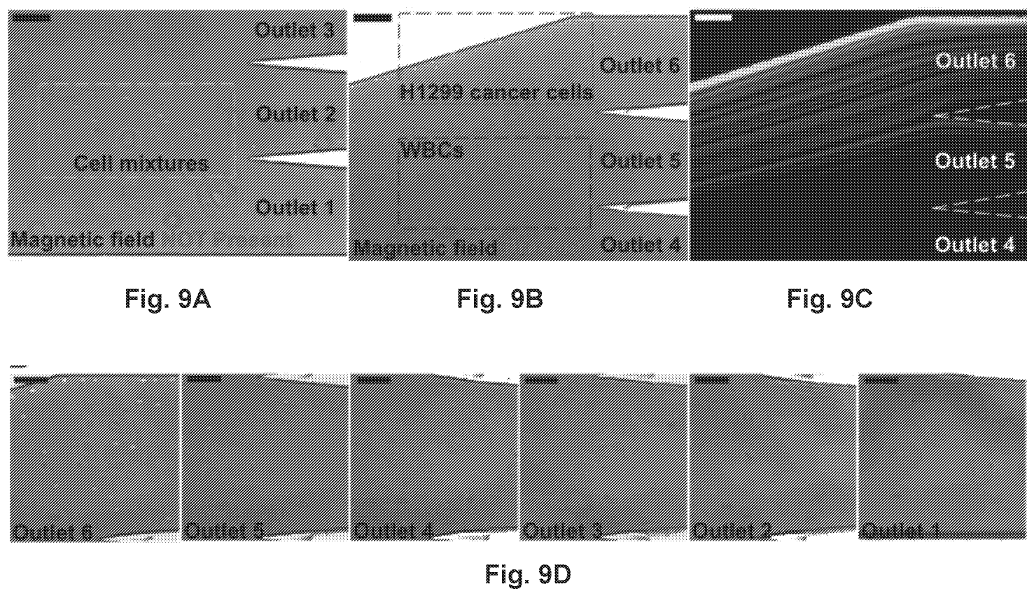

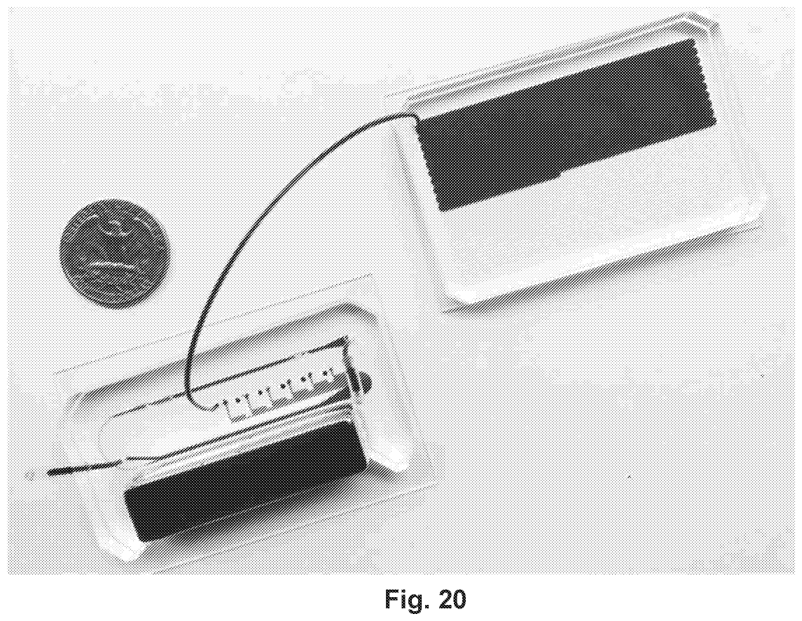

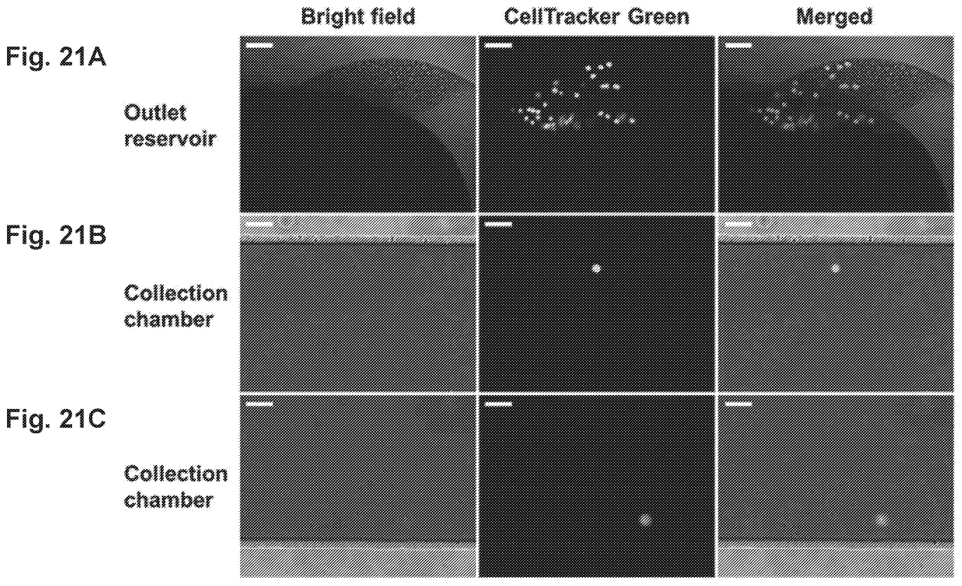

We performed experimental verification of high-throughput, high-recovery and biocompatible separation of spiked cancer cells of cultured cell lines from WBCs based on the optimal parameters obtained from simulation and calibration. During separation experiments, a permanent magnet was placed 1 mm away from the channel (magnetic field: 443 mT, magnetic field gradient: 56.2 T m⁻¹), and ferrofluids with a concentration of 0.26% (v/v) were used. We first studied the CTC recovery rate at different flow rates using spiked H1299 lung cancer cells in WBCs. The concentration of WBCs was 3-7×10⁶ cells mL⁻¹; CTCs were simulated by spiking ˜100 CellTracker Green stained H1299 cancer cells into 1 mL of WBCs. The cells were loaded into a FCS device at variable flow rates of 1.2-6 mL h⁻¹ for recovery rate evaluation. FIGS. 9A-D shows a typical cancer cell (Lung cancer H1299) separation process in the FCS device. When the magnetic field was not present, all cell types including cancer cells and WBCs were flowing near the bottom sidewall of the channel and exiting through outlets 1 and 2 (FIG. 9A). When the magnetic field was present, a separation between cancer cells and WBCs was visible. Magnetic buoyancy forces deflected larger H1299 cancer cells with a mean diameter of 16.9 μm from the cell mixture toward outlets 5 and 6, as shown in FIG. 9B-D. Meanwhile, magnetic buoyancy forces on WBCs were insufficient to deflect them about outlet 5, resulting in a spatial separation of the cell mixtures at the end of the channel. Cells from outlets 5 and 6 after separation were collected into a serpentine collection chamber as illustrated in FIG. 20, which was used to accurately enumerate fluorescently labeled cancer cells. Representative images for outlet 6 reservoir and collection chambers are shown in FIG. 21A-C. The recovery rate was defined as the ratio of the number of identified cancer cells collected from outlets 5 and 6 of the FCS device over the total number of spiked cancer cells from outlets 1-6.

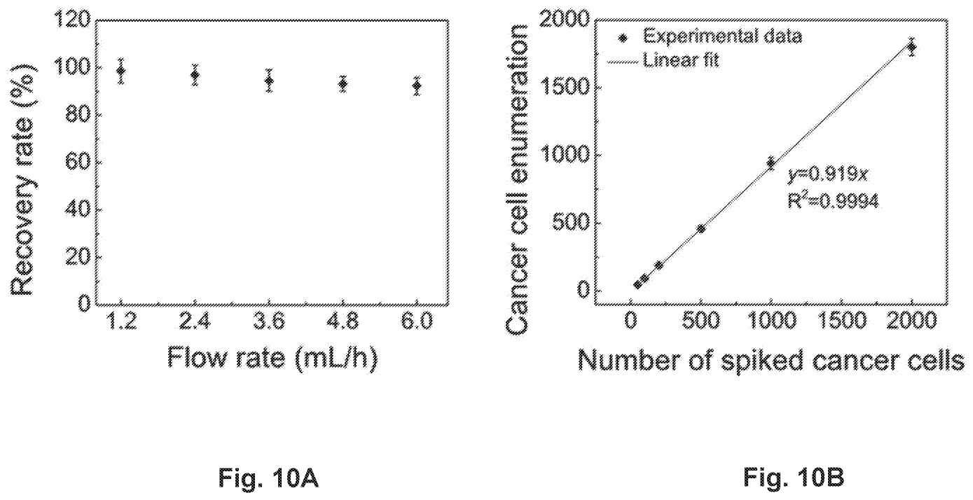

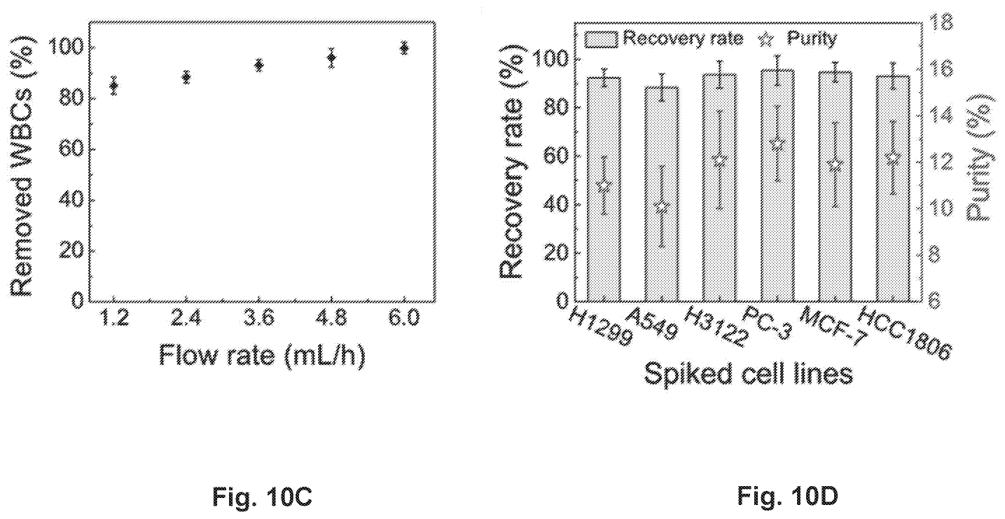

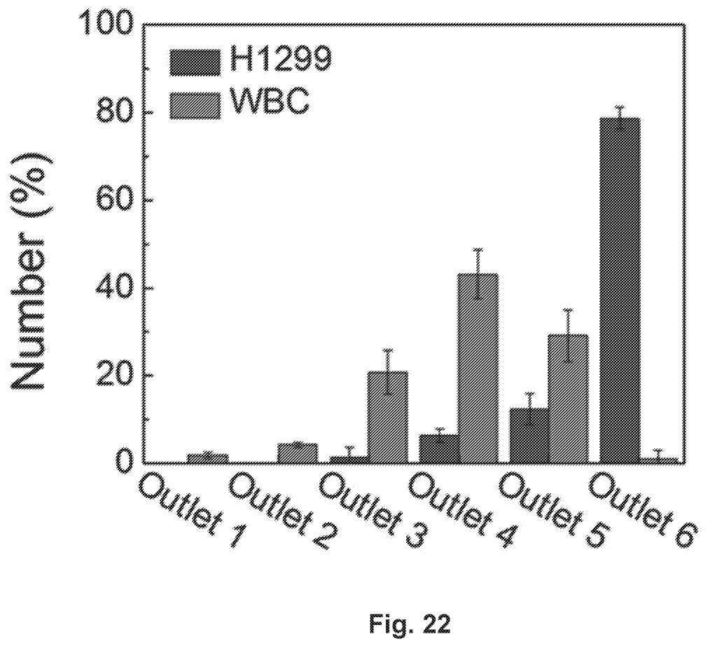

FIG. 10A shows the relationship between cancer cell recovery rates and flow rates for H1299 cancer cells. As flow rates increased from 1.2 mL h⁻¹ to 6 mL h⁻¹, recovery rates decreased from 98.61±5.0% to 92.3±3.6%. An average recovery rate of 92.3% was achieved for current FCS devices with a throughput of 6 mL h⁻¹ when ˜100 H1299 cancer cells were spiked into 1 mL of WBCs. To validate that the device has the potential to process clinically relevant blood samples, a series of spike-in experiments in Which a certain number of H1299 cells (50,100, 200, 500, 1000, and 2000) were spiked into 1 ml of WBCs. As shown in FIG. 10B, an average recovery rate of 91.9% was achieved in the FCS device for this particular lung cancer cell line. FIG. 10C shows the relationship between removal rates of WBCs and cell input flow rates. As the flow rate increased, more WBCs were removed during the separation process. For example, 99.92±2.2% of WBCs were removed at the flow rate of 6 mL h⁻¹ when ˜100 H1299 cancer cells were spiked into 1 mL of WBCs. The corresponding purity of separated cancer cells was 11.1%±1.2%. The purities of separated cancer cells in other spike-in experiments were 4.8%-67.4% (4.8±1.6%, 20.3±2.8%, 31.2±4.7%, 41.7±4.9%, and 67.4±3.3% when 50, 200, 500, 1000, and 2000 H1299 cancer cells were spiked into 1 mL of WBCs). The purity was defined as the number of identified cancer cells over the total number of cells from FCS device's collection outlets. As the number of spiked cells increased, the number of separated cancer cells also increased, which leaded to a higher purity value. The cell type distribution in each outlet is illustrated in FIG. 22.

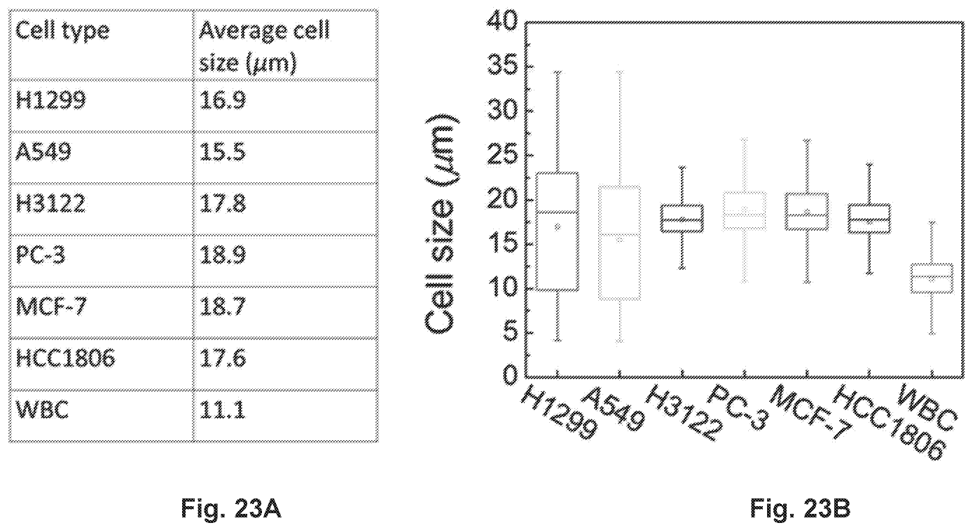

After successfully demonstrating low-concentration cancer cell separation using H1299 lung cancer cell line, we also characterized the FCS device with 5 other types of cancer cells lines. Size distribution of CTCs from clinical samples is unknown, it is therefore important to characterize the performance of FCS devices with cancer cell culture lines with different sizes. For this purpose, lung cancer, prostate cancer, and breast cancer cell culture lines were used to characterize the cancer cell recovery rates at 6 mL h⁻¹ throughput with a ˜100 cell mL⁻¹ spike ratio. As shown in FIG. 1013, the average recovery rates of 88.3±5.5%, 93.7±5.5%, 95.3±6.0%, 94.7±4.0%, and 93.0±5.3% were achieved for A549 (lung cancer), H3122 (lung cancer), PC-3 (prostate cancer), MCF-7 (breast cancer), and HCC1806 (breast cancer) cell lines, respectively. The corresponding purifies of separated cancer cells for each cell line were 10.1±1.7% (A549), 12.1±2.1% (H3122), 12.8±1.6% (PC-3), 11.9±1.8% (MCF-7), and 12.2±1.6% (HCC1806), confirming the robustness of the FCS device for cancer cell separation. The recovery rate increased as the mean cell size of cancer cells increased (Table 2.1 and FIG. 23), which was expected as FCS was based on size difference of cell types. In summary, we experimentally verified that the optimized FCS device was capable of separating cancer cells from WBCs with a flow rate of 6 mL h⁻¹, with a cancer cell recovery rate of 92.9% and a separated cancer cell purity of 11.7% averaged from all 6 cancer cell lines at 100 cell mL⁻¹ spike ratio, which allowed us to use the devices to process the clinical samples.

TABLE 2.1
Rare cell separation with spiked cancer cells from cultured cell lines. ~100 cancer
cells were spiked into 1 mL of undiluted WBCs (3-7 × 10⁶ cells mL⁻¹). The recovery rate was
defined as the ratio of the number of identified cancer cells collected from collection outlets
(outlets 5 and 6) over the total number of spiked cancer cells from all outlets. The purity was
defined as the number of identified cancer cells over the total number of cells from FCS
device's collection outlets. Waste outlets were outlet 1-4. Size of cells were measured and
summarized below (see also FIG. 23). Data are expressed as mean ± standard deviation (s.d.),
n = 3.

| | | Measured | No. of | | No. of | | |
|---|---|---|---|---|---|---|---|
| | | average cell | spiked | No. of cells | cells | | |
| Cancer | Cancer | diameter | cancer | (collection | (waste | Recovery | |
| cell line | cell type | (μm) | cells | outlets) | outlets) | rate | Purity |
| A549 | Lung | 15.5 | 99 ± 2 | 89 ± 4 | 10 ± 6 | 88.3 ± 5.5% | 10.1 ± 1.7% |
| H1299 | Lung | 16.9 | 99 ± 3 | 91 ± 1 | 8 ± 4 | 92.3 ± 3.6% | 11.1 ± 1.2% |
| HCC1806 | Breast | 17.6 | 100 ± 4 | 93 ± 4 | 7 ± 4 | 93.0 ± 5.3% | 12.2 ± 1.6% |
| H3122 | Lung | 17.8 | 101 ± 4 | 92 ± 6 | 9 ± 4 | 93.7 ± 5.5% | 12.1 ± 2.1% |
| MCF-7 | Breast | 18.7 | 100 ± 3 | 94 ± 3 | 6 ± 3 | 94.7 ± 4.0% | 11.9 ± 1.8% |
| PC-3 | Prostate | 18.9 | 100 ± 7 | 95 ± 7 | 5 ± 7 | 95.3 ± 6.0% | 12.8 ± 1.6% |

### Effect of FCS on Cancer Cell Viability, Proliferation and Biomarker Expressions

As discussed above, the operating parameters of the FCS device need to preserve cell integrity during its cell separation process. To investigate the impact of ferrofluids and current separation conditions on cell integrity, we examined short-term cell viability, long-term cell proliferation, as well as biomarker expression of cancer cells following the separation process.

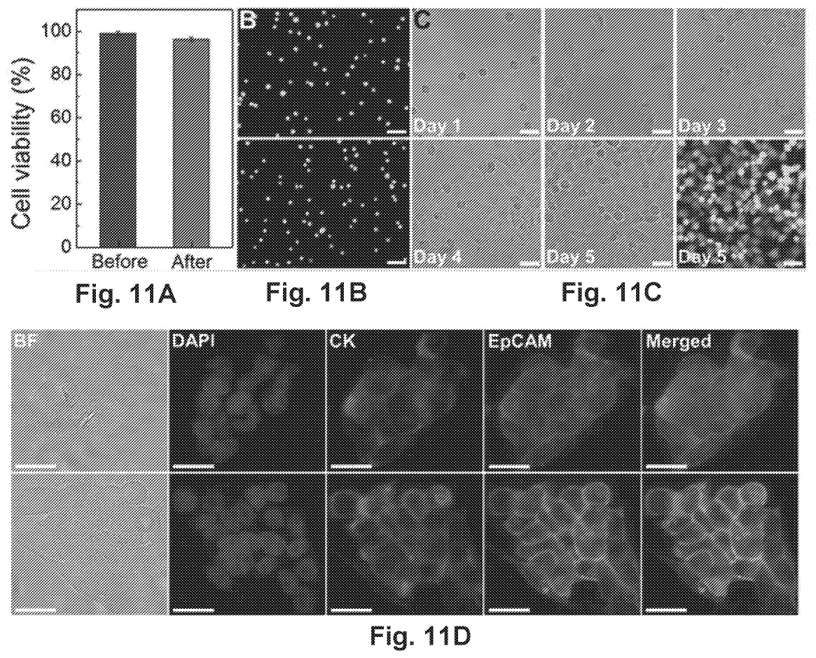

The short-term viability of cancer cells in ferrofluids was first evaluated by 3-(4,5-dimethylthiazol-2-yl)-2,5-diphenyl-tetrazolium bromide (NTT) assay for 12-h incubation with different concentrations of ferrofluids. The results show that H1299 lung cancer cells had a cell viability of 80.8±2.4% after 12-h incubation with 0.26% (v/v) ferrofluids as shown in FIG. 19A-D. Next, we investigated the short-term cell viability after ferrohydrodynamic cell separation using a Live/Dead assay. Cells in 1 mL of ferrofluids (1×10⁶ H1299 cells) were processed by the FCS device at a flow rate of 6 mL h⁻¹. The device-operating parameters were chosen to be the same as those used in aforementioned cancer cell separation experiments. After running the cell sample through the device, cancer cells collected from outlet 6 were stained with 2 μM calcein-AM and 4 Mm EthD-1 for 30 minutes at room temperature to determine their viability. Cells with a calcein-AM+H/EthD-1− staining pattern were counted as live cells, whereas cells with calcein-AM−/EhD-1+ staining patterns were counted as dead cells. As shown in FIG. 11A, cell viability of H1299 cells before and after separation groups were determined to be 98.9±0.9% and 96.3±0.9%, respectively, indicating a very slight decrease in cell viability before and after the ferrohydrodynamic separation process. Representative fluorescence images of cells are shown in FIG. 11B.

After determining short-term cell viability, we examined whether separated cancer cells continued to proliferate normally after the separation process. To simulate the actual separation conditions, 1×10⁶ H1299 cells were spiked into 1 mL of ferrofluids and passed through the FCS device. The flow rate and ferrofluid concentration were chosen to be the same as those used in cancer cell separation experiments. Following cell collection, the recovered H1299 cells were washed with culture medium to remove maghemite nanoparticles and transferred to an incubator. Cells were cultured at 37° C. under a humidified atmosphere of 5% CO₂. FIG. 11C shows the images of the cultured H1299 cells over a 5-day period. These cells were able to proliferate to confluence and maintain their morphologies after the ferrohydrodynamic separation process. Fluorescence image in FIG. 11C also confirms that cells were viable after the 5-day culture.

In order to determine whether the FCS process would alter the expression of cell surface biomarkers, we looked for changes in biomarker expression using immunofluorescence staining. Specifically, we compared expressions of epithelial cell adhesion molecule (EpCAM) and cytokeratin (CK), two key biomarkers in CTC studies, in paired sets of pre- and post-FCS process. Results shown in FIG. 11D indicate there was no visible change in either EpCAM or CK expression on HCC1806 breast cancer cells because of the FCS process. Collectively, the short-term viability, long-term cell proliferation and biomarker studies presented here demonstrated that the FCS method was biocompatible for cancer cell separation and could enable downstream characterization of separated CTCs.

### Enrichment of CTCs from NSCLC Patient Blood Using FCS

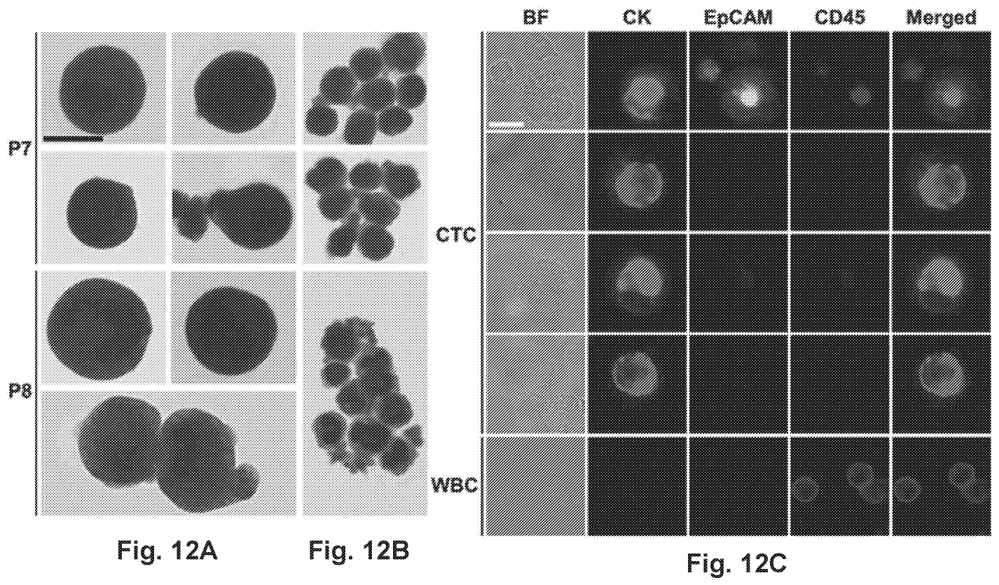

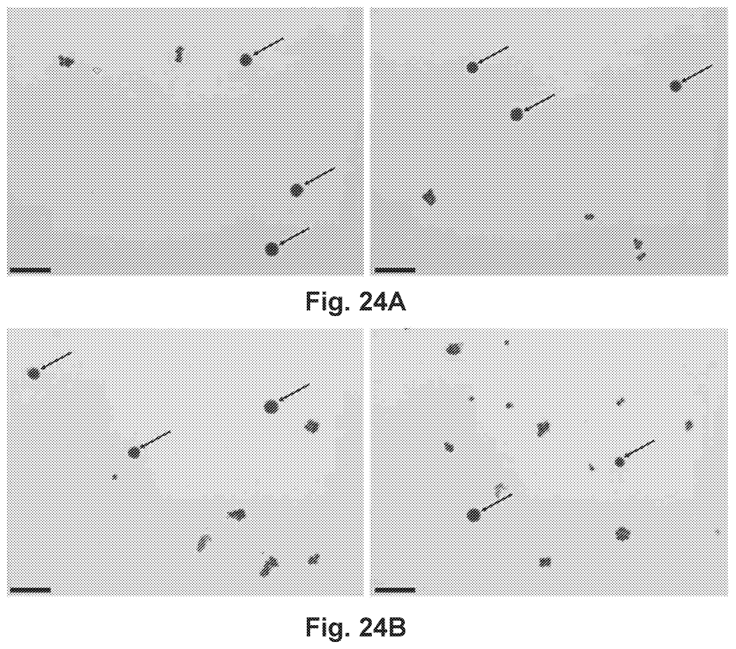

There was a large variance in reported numbers of captured CTCs for advanced metastatic cancer patients,⁵ The exact reasons for this variance are still an area of active research. Nonetheless, most CTC separation methods chose to use blood from advanced metastatic patients for technology validation.^{11, 16, 20-25, 29, 30} As a clinical validation of this method, we validated FCS devices with blood samples obtained from two patients with advanced NSCLC. Peripheral blood was collected from patients with newly diagnosed NSCLC (stage IVB) before initiation of treatment. Blood was lysed to remove RBCs and then processed with FCS devices within 3 hours of blood draw. 6.5 mL of blood was processed from patient A, and 5.6 mL of blood was processed from patient B. After separation, cells from FCS device's outlet 6 were directly preserved in ThinPrep PreservCyt solution. These enriched cells were concentrated and stained using the Pap stain, which was commonly used for cytopathology analysis of clinical samples. Enriched cells were then inspected by a cytopathologist and CTCs were enumerated. Criteria used to identify CTC were as follows: (1) large cells with high nuclear to cytoplasmic ratio; (2) cells with irregular chromatin distribution and nuclear contours; (3) cells that are 4-5 times the size of a WBC. FIG. 12A and FIG. 24A-B show a few Pap-stained CTCs and WBCs separated from two NSCLC patients. Both patients showed high CTC counts through cytopathology: 1165 and 369 CTCs were identified from 6.5 and 5.6 mL of blood samples, respectively. Purity of CTCs (defined as the number of identified CTCs over the total number of cells from FCS device's collection outlets) from these two patients was 17.0±7.8%. Additionally, Immunofluorescent staining of CK8/18/19, EpCAM, and leukocyte marker CD45 was also used to confirm the presence CTCs separated from patient B's blood. Cells were identified as CTCs if the staining pattern is CK+F/CD45− or EpCAM+/CD45− or CK+/EpCAM+/CD45−, otherwise, cells were identified as WBCs. Typical fluorescent images are shown in FIG. 12B based on this immunostaining detection criteria.

### Three-Dimensional Model of Ferrohydrodynamic Cell Separation (FCS)

Cell or bead trajectories are simulated in a three-dimensional (3D) FCS device (relevant dimensions are listed in FIG. 14A-B) by slight modifications of previously developed models with cell properties from cancer cell, white blood cells (WBCs) and relevant beads.^{50,51} We first calculate the 3D magnetic buoyancy force via an experimentally verified and analytical distribution of magnetic fields as well as their gradients, together with a nonlinear magnetization model of the custom-made ferrofluid. In order to simulate the magnetic field distribution in the channel generated from the permanent magnet, we followed the 3 steps as below:
1. We experimentally measured flux density at the center of magnet's polar surface, and points away from surface to obtain a flux density-distance relationship (see FIG. 13).
2. From measured flux density-distance plot, we determined value of remnant magnetization of the permanent magnet. This value was used in the magnetic field simulation based on a set of governing equations,^{50,57} in order to generate a simulated. flux density-distance relationship. We compared the experimental and simulated flux density-distance relationship and they were within 5.81% error range.
3. The simulated magnetic field distribution (flux density, strength, and gradient) was then confirmed to be valid and used in subsequent FCS device optimizations. The magnetic buoyancy force is expressed as,

\vec{F}ₘ=μ₀V_{c}[(\vec{M}_{c}−\vec{M}_{f})·∇]\vec{H} [4]

where μ₀=4π10⁻⁷ H/m is the permeability of free space. V_{c} is the volume of a single cell, [symbol] _{c} is its magnetization, [symbol] _{f} is magnetization of the magnetic fluid surrounding the body, and [symbol] is the magnetic field strength at the center of the body.⁴⁴ The magnetization of the ferrofluid [symbol] _{f} under an external field [symbol] is a Langevin function,

$${\vec{M}}_{f} = ( coth ( {α}_{f} ) - \frac{1}{{α}_{f}} ) φ {\vec{M}}_{f , b} \qquad [ 5 ]$$

where α_{f}=μ₀πM_{f,b}Hd³_{f}/6k_{B}T. M_{f,b} is saturation moments of the bulk magnetic materials, d_{f} is diameters of magnetic nanoparticles in ferrofluid, κ_{B} is the Boltzmann constant T is the temperature. ϕ is the concentration (volume fraction) of the magnetic nanoparticles in the ferrofluid.⁴⁴

We also derived the hydrodynamic viscous drag force with velocity difference between the cell and the local flow,

\vec{F}_{d}=−2πηD_{c}(\vec{U}_{c}−\vec{U}_{f})f_{D} [6]

where η is viscosity of magnetic fluids, D_{c} is diameter of a spherical cell, \vec{U}_{c} and \vec{U}_{f} are velocity vectors of the cell and the fluids respectively, f_{D} is hydrodynamic drag force coefficient of a moving cell considering the influence with a solid surface in its vicinity, which is referred to as the “wall effect”.⁵²⁻⁵⁴ The velocity vectors of the fluids \vec{U}_{f} were extracted from a 3D velocity profile simulation generated in COMSOL Multiphysics (Version 3.5, COMSOL Inc., Burlington, Mass.) through an interpolation method. The COMSOL simulation was conducted with exact conditions of experiments.

We finally solved governing equations of motion using analytical expressions of magnetic buoyancy force and hydrodynamic viscous drag force. Because of the low Reynolds number in a microchannel, inertial effects on the particle are negligible. Motion of a non-magnetic cell in ferrofluids is determined by the balance of hydrodynamic viscous drag force and magnetic buoyancy force.

\vec{F}ₘ+\vec{F}_{d}=0. [7]

This equation was solved by using a fourth-order Runge-Kutta time integration scheme in MATLAB (MathWorks Inc., Natick, Mass.).

We first confirmed the validity of the model by comparing simulated trajectories (FIG. 15A-B) with experimental ones (FIG. 16) that were obtained from imaging 16.9-μm-diameter H1299 cells (emulated with beads of similar size) and 11.1-μm-diameter WBCs in a FCS device. From Fig. S5, the simulated cell trajectories generated by the model matched the experimental one very well. We then started to use the model for FCS optimizations. The dimensions of the channel were listed in FIG. 14A-B. Concentration of ferrofluid was 0.26% (v/v) and the viscosity was measured to be 2.92 mPa·s. Average diameters of WBC and H1299 cells were 11.1 μm and 16.9 μm. Dimensions of the permanent magnet were 50800 μm (length)×12700 μm (width)×12700 μm (height) and the B field at the polar surface was measured to be 0.5 T.

Synthesis and characterization of biocompatible ferrofluids. Ammonium hydroxide solution (28%), iron (II) chloride tetrahydrate (99%), iron (III) chloride hexahydrate (97%), nitric acid (70%), iron (III) nitrate nonahydrate (98%), and sodium hydroxide (98%) were purchased from a commercial vendor (Sigma-Aldrich, St. Louis, Mo.). All reagents were used as received. Maghemite nanoparticles were synthesized by a chemical co-precipitation method.⁴ In a typical reaction, 50 mL of ammonium hydroxide solution was quickly added to a mixture of 100 mL of 0.4 M iron (II) chloride tetrahydrate and 0.8 M iron (III) chloride hexahydrate, and was followed by stirring at room temperature for 30 minutes. The suspension was then centrifuged at 2000×g for 3 minutes and the precipitate was dispersed in 200 mL of 2 M nitric acid and 0.35 M iron (III) nitrate nonahydrate. The mixture was maintained at 90° C. for 1 hour. During this time, the color of the mixture changed from black (Fe₃O₄) to reddish brown (Fe₂O₃). The magheinite nanoparticle suspension was centrifuged at 3000×g for 3 minutes and finally dispersed in 120 mL of deionized (DI) water, yielding a stable dispersion with a pH of 1.5-2. The pH of the dispersion was adjusted to 2.9 by 1 M sodium hydroxide solution. 40 mL of Atlox 4913 (Croda, Edison, N.J.), a graft copolymer solution, was added to the dispersion and stirred for 5 minutes before raising pH to 7.0. The dispersion was then vigorously stirred at room temperature for 1 hour, and the resulted ferrofluid was dialyzed with a dialysis membrane (Spectrum Labs, Rancho Dominguez, Calif.) against DI water for one week. DI water was refreshed every 24 hours. After dialysis, excess water was vaporized at 72° C. Finally, 10% (v/v) 10× Hank's balanced salt solution (HBSS; Life Technologies, Carlsbad, Calif.) was added into the ferrofluid to render it isotonic for cells followed by adjusting pH to 7.0. Sterile filtration of ferrofluid was performed with a 0.2 μm filter (VWR, Radnor, Pa.) and ferrofluids were exposed to UV light for 12 hours before experimental use.

Size and morphology of maghemite nanoparticles were characterized via transmission electron microscopy (TEM; FEI, Eindhoven, the Netherlands). Magnetic properties of the ferrofluid were measured at room temperature using a vibrating sample magnetometer (VSM; MicroSense, Lowell, Mass.) with a 2.15 T electromagnet. The magnetic moment of ferrofluid was measured over a range of applied fields from −21.5 to +21.5 kOe. The measurements were conducted in step field mode at a stepsize of 250 Oe s⁻¹. Zeta potential of the ferrofluid was measured with a Zetasizer Nano ZS (Malvern Instruments, Westborough, Mass.). The hydrodynamic diameter of nanoparticles was measured by dynamic light scattering (DLS). The viscosity of ferrofluids was characterized with a compact rheometer Anton Paar, Ashland, Va.) at room temperature.

### Discussion

In this paper, we developed a ferrohydrodynamic cell separation (FCS) method for CTC separation and its devices that were capable of high-throughput (6 mL h⁻¹), high recovery rate (92.9%, an average from 6 cancer cell lines at ˜100 cell mL⁻¹ spike ratio) and biocompatible enrichment of cancer cells from RBC-lysed blood with an average 11.7% purity, by systematically investigating the device operating parameters on its separation performance. The FCS process involved multiple parameters that could affect the cell separation performance, including cell flow rates, magnetic fields and its gradient, ferrofluid concentrations and compositions. All of these parameters were highly coupled with each other and required an effective model for device optimization. We have developed and validated such an analytical model that considered magnetic buoyancy force, hydrodynamic drag force, laminar flow profiles and cancer/blood cell physical properties to guide the optimization and design of a high-throughput, high recovery rate FCS devices. We also considered the chemical makeup of the ferrofluids, including its nanoparticle concentration, pH value, nanoparticle size and surfactant, tonicity to optimize a colloidally stable and biocompatible ferrofluid suitable for cancer cell separation. After systematic optimization, we demonstrated that FCS devices were capable of separating various types of low-concentration cancer cells of cultured cell lines (˜100 cell mL⁻¹) from WBCs under a flow rate of 6 mL h⁻¹. The recovery rates of spiked cancer cells were on average 92.9% from all tested cell lines at clinically relevant CTC occurrence rates. The recovered cancer cells were viable, could proliferate to confluence and expressions of a few key biomarker remained unaffected. These results indicated the practical use of this method in separating CFCs from patient blood were feasible. We further demonstrated FCS devices worked well with clinical samples by successfully separating and identifying CTCs from blood samples of two late-stage (IVB) non-small cell lung cancer patients.

While current FCS devices demonstrated a high-recovery and biocompatible separation of rare cancer cells at a clinically relevant throughput, and was validated with NSCLC patient blood, it was still at its early stage of development and could benefit from further system optimization or integration with other methods in order to achieve high-throughput, high-recovery, and high-purity separation of intact CTCs. When comparing FCS performance to other size-based label-free CTC separation methods, its rate of recovery of cancer cells was higher than the current average reported value of 82%,⁸ including methods based on standing surface acoustic wave (>83%),¹⁶ dean flow (>85%),²⁰⁻²² vortex technology (up to 83%),²³⁻²⁵ and deterministic lateral displacement (>85%).⁵⁵ Although the throughput of current FCS device (6 mL h⁻¹) was sufficiently high to process clinically relevant amount of blood, it was slower than a few hydrodynamics-based methods that had extremely high flow rates, including the dean flow (56.25 mL h^{'1}),²⁰⁻²² the vortex technology (48 mL h⁻¹),²³⁻²⁵ and DLD (10 mL min⁻¹).⁵⁵ Further system optimization, scale-up or multiplexing of FCS devices should be conducted in order to process more blood quickly. The average purity of separated cancer cells in current FCS devices was 11.7%. Reported purity values varied dramatically from 0.1% to 90% in label-free methods,¹⁶⁻²⁵ as most of them focused on improving recovery instead of purification of rare cells. Nonetheless, hydrodynamics-based methods including the dean flow (50%)²⁰⁻²² and the vortex technology (57-94%)²³⁻²⁵ reported significantly higher purity of cancer cells in their collection outputs than FCS. Low cancer cell purity due to WBC or other cell contamination could interfere with subsequent CTC characterization. It is therefore necessary for future FCS devices to further deplete these contamination cells.

FCS currently distinguished cells primarily based on their size difference. For cancer cells that have similar size as WBCs, this method will result in lower separated cancer cell purity than label-based method. Additional cell characteristics or methods could be integrated with FCS to further improve the purity of separated cancer cells. One possible strategy is for future FCS devices to exploit both size and magnetic labels of cells for CTC separation.⁵⁶ For example, WBCs in blood can be labeled with sufficient number of anti-CD45 magnetic beads so that the overall magnetization of the WBC-bead complex \vec{M}_{WBC-Bead} is larger than its surrounding ferrofluids \vec{M}_{f}. The direction of magnetic force on the complex is then pointing towards magnetic field maxima. On the other hand, magnetization of the non-labeled CTCs \vec{M}_{CTC} is zero and less than its surrounding ferrofluids \vec{M}_{f}, the direction of magnetic force on CTCs is therefore pointing towards magnetic field minima. In this scenario, both label-based magnetophoresis and size-based FCS co-exist in one system, i.e., \vec{M}_{CTC-bead}>\vec{M}_{f}>\vec{M}_{CTC}, magnetic three will attract WBC-bead complex towards field maxima while pushes CTCs towards field minima.

### Conclusions

In the present disclosure, we reported a label-free ferrohydrodynamic cell separation (FCS) method that used magnetic buoyance force for size-based CTC separation, which was biocompatible and could enrich rare CTCs from patient blood with a high throughput and a high rate of recovery. We performed systematic optimization of this method and determined parameters in a laminar flow microfluidic device that achieved an average 92.9% recovery rate and an average 11.7% purity of low-concentration (˜100 cells mL⁻¹) cancer cells using six different cultured cell lines from undiluted WBCs, with a clinically relevant processing throughput of 6 mL of per hour. These parameters include magnetic field and its gradient (magnetic field: 443 mT, magnetic field gradient: 56.2 T m⁻¹), and ferrofluid concentration (0.26%, v/v). Specifically, for each cell lines at 100 cell mL⁻¹ spike ratio, the recovery rates of cancer cells were 92.3±3.6% (H1299 lung cancer), 88.3±5.5% (A549 lung cancer), 93.7±5.5% (H3122 lung cancer), 95.3±6.0% (PC-3 prostate cancer), 94.7±4.0% (MCF-7 breast cancer), and 93.0+5.3% (HCC1806 breast cancer), and the corresponding purities of separated cancer cells were 11.1%±1.2% (H1299 lung cancer), 10.1±1.7% (A549 lung cancer), 12.1±2.1% (H3122 lung cancer), 12.8±1.6% (PC-3 prostate cancer), 11.9±1.8% (MCF-7 breast cancer), and 12.2±1.6% (HCC1806 breast cancer). Separated H1299 lung cancer cells from FCS showed a short-term viability of 96.3±0.9%, and they were successfully cultured and demonstrated normal proliferation to the confluence. Separated HCC1806 breast cancer cells from FCS showed unchanged expressions of two key biomarkers including EpCAM and CK. FCS devices were validated with blood samples obtained from two patients with advanced. NSCLC, 1165 CTCs were enriched and identified from 6.5 mL of blood samples from one patient, while 369 CTCs were enriched and identified from 5.6 mL of blood samples from the other patient. Although FCS is still at its early stage of development, it could be a complementary tool for rare cell separations because of its high recovery rate and excellent biocompatibility, as well as its potential for further optimization and integration with other compatible methods.

### References for Example 2

1. N. Aceto, M. Toner, S. Maheswaran and D. A. Haber, Trends in Cancer, 2015, 1, 44-52.
2. J. Massague and A. C. Obenauf, Nature, 2016, 529, 298-306.
3. M. Yu, A. Bardia, N. Aceto, F. Bersani, M. W. Madden, M. C. Donaldson, R. Desai, H. L. Zhu, V. Comaills, Z. L. Zheng, B. S. Wittner, P. Stojanov, E. Brachtel, D. Sgroi, R. Kapur, T. Shioda, D. T. Ting, S. Ramaswamy, G. Getz, A. J. Iafrate, C. Benes, M. Toner, S. Maheswaran and D. A. Haber, Science, 2014, 345, 216-220.
4. M. Kalinich, I. Bhan, T. T. Kwan, D. T. Miyamoto, S. Javaid, J. A. LiCausi, J. D. Milner, X. Hong, L. Goyal, S. Sil, M. Choz, U. Ho, R. Kapur, A. Muzikansky, H. D. Zhang, D. A. Weitz, L. V. Sequist, D. P. Ryan, R. T. Chung, A. X. Zhu, K. J. Isselbacher, D. T. Ting, M. Toner, S. Maheswaran and D. A. Haber, P Natl Acad Sci USA, 2017, 114, 1123-1128.
5. C. Alix-Panabieres and K. Pantel, Nat Rev Cancer, 2014, 14, 623-631.
6. M. Yu, S. Stott, M. Toner, S. Maheswaran and D. A. Haber, J Cell Biol., 2011, 192, 373-382.
7. C. Alix-Panabieres and K. Pantel, Clin Chem, 2013, 59, 110-118.
8. Y. C. Chen. P. Li, P. H. Huang, Y. L. Xie, J. D. Mai, L. Wang, N. T. Nguyen and T. J. Huang, Lab Chip, 2014, 14, 626-645.
9. D. T. Miyamoto, D. T. Ting, M. Toner, S. Maheswaran and D. A. Haber, Cold Spring Harbor symposia on quantitative biology, 2016, 81, 269-274.
10. M. Poudineh, P. Aldridge, S. Ahmed, B. J. Green, L. Kermanshah, V. Nguyen, C. Tu, R. M. Mohamadi, R. K. Nam, A. Hansen, S. S. Sridhar, A. Finelli, N. E. Fleshner, A. M. Joshua, E. H. Sargent and S. O. Kelley, Nat Nanotechnol, 2017, 12, 274-281.
11. S. Nagrath, L. V. Sequist, S. Maheswaran, D. W. Bell, D. Irimia, L. Ulkus, M. R. Smith, E. L. Kwak S. Digumarthy, A. Muzikansky, P. Ryan, U. J. Balis, R. G. Tompkins, D. A. Haber and M. Toner, Nature, 2007, 450, 1235-1239.
12. S. L. Stott, C. H. Hsu, D. I. Tsukrov, M. Yu, D. T. Miyamoto, B. A. Waltman, S. M. Rothenberg, A. M. Shah, M. E. Smas, G. K. Korir, F. P. Floyd, A. J. Gilman, J. B. Lord, D. Winokur, S. Springer, D. Irimia, S. Nagrath, L. V. Sequist, R. J. Lee, K. J. Isselbacher, S. Maheswaran, D. A. Haber and M. Toner, P Natl Acad Sci USA, 2010, 107, 18392-18397.
13. A. H. Talasaz, A. A. Powell, D. E. Huber, J. G. Berbee, K. H. Roh, W. Yu, W. Z. Xiao, M. Davis, R. F. Pease, M. N. Mindrinos, S. S. Jeffrey and R. W. Davis, P Natl Acad Sci USA, 2009, 106, 3970-3975.
14. V. Murlidhar, L. Rivera-Baez and S. Nagrath, Small, 2016, 12, 4450-4463.
15. H. K. Lin, S. Y. Zheng, A. J. Williams, M. Balic, S. Groshen, H. I. Scher, M. Fleisher, W. Stadler, R. H. Datar, Y. C. Tai and R. J. Cote, Clin Cancer Res, 2010, 16, 5011-5018.
16. P. Li, Z. M. Mao, Z. L. Peng, L. L. Zhou, Y. C. Chen, P. H. Huang, C. I. Truica, J. J. Drabick, W. S. El-Deiry, M. Dao, S. Suresh and T. J. Huang, P Natl Acad Sci USA, 2015, 112, 4970-4975.
17. S. B. Huang, M. H. Wu, Y. H. Lin, C H. Hsieh, C. L. Yang, H. C. Lin. C. P. Tseng and G. B. Lee, Lab Chip, 2013, 13, 1371-1383.
18. P. R. C. Gascoyne, J. Noshari, T. J. Anderson and F. F. Becker, Electrophoresis, 2009, 30, 1388-1398.
19. H. S. Moon, K. Kwon, S. I. Kim, H. Han, J. Sohn, S. Lee and H. I. Jung, Lab Chip, 2011, 11, 1118-1125.
20. H. W. Hou, M. E. Warkiani, B. L. Khoo, Z. R. Li, R. A. Soo, D. S. W. Tan, W. T. Lim, J. Han, A. A. S. Bhagat and C. T. Lim, Sci Rep, 2013, 3, 1259
21. M. E. Warkiani, G. F. Guan, K. B. Luan, V. C. Lee, A. A. S. Bhagat, P. K. Chaudhuri, D. S. W. Tan, W. T. Lim, S. C. Lee, P. C. Y. Chen, C. T. Lim and J. Han, Lab Chip, 2014, 14, 128-137.
22. M. E. Warkiani, B. L. Khoo, L. D. Wu, A. K. P. Tay, A. A. S. Bhagat, J. Han and C. T. Lim, Natl Protoc, 2016, 11, 134-148.
23. J. Che, V. Yu, M. Dhar, C. Renier, M. Matsumoto, K. Heirich, E. B. Garon, J. Goldman, J. Y. Rao, G. W. Sledge, M. D. Pegram, S. Sheth, S. S. Jeffrey, R. P. Kulkarni, E. Sollier and D. Di Carlo, Oncotarget, 2016, 7, 12748-12760.
24. M. Dhar, E. Pao, C. Renier, D. E. Go, J. Che, R. Montoya, R. Conrad, M. Matsumoto, K. Heirich, M. Triboulet, J. Y. Rao, S. S. Jeffrey, E. B. Garon, J. Goldman, N. P. Rao, R. Kulkami, E. Sollier-Christen and D. Di Carlo, Sci Rep, 2016, 6, 35474.
25. E. Sollier, D. E. Go, J. Che, D. R. Gossett, S. O'Byrne, W. M. Weaver, N. Kummer, M. Rettig, J. Goldman, N. Nickols, S. McCloskey, R. P. Kulkarni and D. Di Carlo, Lab Chip, 2014, 14, 63-77.
26. D. Marrinucci, K. Bethel, D. Lazar, J. Fisher, E. Huynh, P. Clark, R. Bruce, J. Nieva and P. Kuhn, Journal of Oncology, 2010, 2010, 861341.
27. W. J. Allard, J. Matera, M. C. Miller, M. Repollet, M. C. Connelly, C. Rao, A. G. J. Tibbe, J. W. Uhr and L. W. M. M. Terstappen, Clin Cancer Res, 2004, 10, 6897-6904.
28. Y. Dong, A. M. Skelley, K. D. Merdek, K, M. Sprott, C. Jiang, W. E. Pierceall, J. Lin, M. Stocum, W. P. Camey and D. A. Smirnov, The Journal of molecular diagnostics: JMD, 2013, 15, 149-157.
29. N. M. Karabacak, P. S. Spuhler, F. Fachin, E. J. Lim, V. Pai, E. Ozkumur, J. M. Martel, N. Kojic, K. Smith, P. I. Chen, J. Yang, H. Hwang, B. Morgan, J. Trautwein, T. A. Barber, S. L. Stott, S. Maheswaran, R. Kapur, D. A. Haber and M. Toner, Nat Protoc, 2014, 9, 694-710.
30. E. Ozkumur, A. M. Shah, J. C. Ciciliano, B. L. Emmink, D. T. Miyamoto, E. Brachtel, M. Yu, P. I. Chen, B. Morgan, J. Trautwein, A. Kimura, S. Sengupta, S. L. Stott, N. M. Karabacak, T. A. Barber, J. R. Walsh, K. Smith, P. S. Spuhler, J. P. Sullivan, R. J. Lee, D. T. Ting, X. Luo, A. T. Shaw, A. Bardia, L. V. Sequist, D. N. Louis, S. Maheswaran, R. Kapur, D. A. Haber and M. Toner, Sci Transl Med. 2013, 5, 179ra147.
31. C. W. Shields, J. L. Wang, K. A. Ohiri, E. D. Essoyan, B. B. Yellen, A. J. Armstrong and G. P. Lopez, Lab Chip, 2016, 16, 3833-3844.
32. C. Huang, H. Liu, N. H. Bander and B. J. Kirby, Biomed Microdevices, 2013, 15, 941-948.
33. Z. B. Liu, W. Zhang, F. Huang, H. Feng, L. Shu, X. P. Xu and Y. Chen, Biosens Bioelectron, 2013, 47, 113-119.
34. J. Kim, H. Cho, S. I. Han and K. H. Han, Anal Chem, 2016, 88, 4857-4863.
35. B. D. Plouffe, M. Mahalanabis, L. H. Lewis, C. M. Klapperich and S. K. Murthy, Anal Chem, 2012, 84, 1336-1344.
36. C. M. Earhart, C. E. Hughes, R. S. Gaster, C. C. Ooi, R. J. Wilson, L. Y. Zhou, E. W. Humke, L. Y. Xu, D. J. Wong, S. B. Willingham, E. J. Schwartz, I. L. Weissman, S. S. Jeffrey, J. W. Neal, R. Rohatgi, H. A. Wakeleebe and S. X. Wang, Lab Chip, 2014, 14, 78-88.
37. J. H. Kang, S. Krause, H. Tobin, A. Mammoto, M. Kanapathipillai and D. E. Ingber, Lab Chip, 2012, 12, 2175-2181.
38. Hoshino, Y. Y. Huang, N. Lane, M. Huehschman, J. V. Uhr, E. P. Frenkel and X. J. Zhang, Lab Chip, 2011, 11, 3449-3457.
39. A. E. Saliba, L. Saias, E. Psychari, N. Mine, D. Simon, F. C. Bidard, C. Mathiot, J. Y. Pierga, V. Fraisier, J. Salamero, V. Saada, F. Farace, P. Vielh, L. Malaquin and J. L. Viovy, P Natl Acad Sci USA, 2010, 107, 14524-14529.
40. L. Y. Yang. J. C. Lang, P. Balasubramanian, K. R. Jatana, D. Schaller, A. Agrawal, M. Zborowski and J. J. Chalmers, Biotechnol Bioeng, 2009, 102, 521-534.
41. Y. Y. Huang, P. Chen, C. H. Wu, K. Hoshino, K. Sokolov, N. Lane, H. Y. Liu, M. Huebschman, E. Frenkel and J. X. J. Zhang, Sci Rep, 2015, 5, 16047.
42. W. Zhao, R. Cheng, J. R. Miller and L. Mao, Advanced Functional Materials, 2016, 26, 3916-3932.
43. A. T. Skjeltorp, Phys Rev Lett, 1983, 51, 2306-2309.
44. R. E. Rosensweig, Ferrohydrodynamics, Cambridge University Press, Cambridge, 1985.
45. T. T. Zhu, R. Cheng, S. A. Lee, E. Rajaraman, M. A. Eiteman, T. D. Querec, E. R. Unger and L. D. Mao, Microfluid Nanofluid, 2012, 13, 645-654.
46. J. Zeng, Y. X. Deng, P. Vedantam, T. R. Tzeng and X. C. Xuan, J Magn Magn Mater, 2013, 346, 118-123.
47. A. R. Kose, B. Fischer, L. Mao and H. Koser, P Natl Acad Sci USA, 2009, 106, 21478-21483.
48. W. Zhao, T. Zhu, R. Cheng, Y. Liu, J. He, H. Qiu, L. Wang, I. Nagy, I. D. Querec, E. R. Unger and L. Mao, Advanced Functional Materials, 2016, 26, 3990-3998.
49. W. Zhao, R. Cheng, S. H. Lim, J. R. Miller, W. Zhang, W. Tang, J. Xie and L. Mao, Lab Chip, 2017, 17, 2243-2255.
50. R. Cheng, T. T. Zhu and L. D. Mao, Microfluid Nanofluid, 2014, 16, 1143-1154.
51. T. T. Zhu, D. J. Lichlyter M. A. Haidekker and L. D. Mao, Microfluid Nanofluid, 2011, 10, 1233-1245.
52. P. Ganatos S. Weinbaum and R. Pfeffer, J Fluid Mech, 1980, 99, 739-753.
53. G. P. Krishnan and D. T. Leighton, Phys Fluids, 1995, 7, 2538-2545.
54. M. E. Staben, A. Z. Zinchenko and R. H. Davis, Phys Fluids, 2003, 15, 1711-1733.
55. K. Loutherback, J. D'Silva, L. Y. Liu, A. Wu, R. H. Austin and J. C. Sturm, Aip Adv, 2012, 2, 042107.
56. T. T. Zhu, R. Cheng, Y. F. Liu, J. He and L. D. Mao, Microfluid Nanofluid, 2014, 17, 973-982.
57. E. P. Furlani, Permanent magnet and electromechanical devices: materials, analysis, and applications, Academic, San Diego, Calif.; London, 2001.
58. R. Massart, Ieee T Magn, 1981, 17, 1247-1248.

It should be noted that ratios, concentrations, amounts, and other numerical data may be expressed herein in a range format. It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a concentration range of “about 0.1% to about 5%” should be interpreted to include not only the explicitly recited concentration of about 0.1 wt % to about 5 wt %, but also include individual concentrations e.g., 1%, 2%, 3%, and 4%) and the sub-ranges (e.g., 0.5%, 1.1%, 2.2%, 3.3%, and 4.4%) within the indicated range. In an embodiment, the term “about” can include traditional rounding according to the measurement technique and the type of numerical value. In addition, the phrase about ‘x’ to ‘y’” includes “about ‘x’ to about ‘y’”.

Many variations and modifications may be made to the above-described embodiments. All such modifications and variations are intended to be included herein within the scope of this disclosure and protected by the following claims.

1. A method for separating circulating tumor cells from blood cells in a sample of whole blood, comprising:
lysing red blood cells from the sample to form a first fluid comprising a cell mixture;
introducing the first fluid to a device having a microfluidic channel having a first end and a second end, where the first fluid is introduced into the microfluidic channel through a first inlet, and flowing the first fluid through the microfluidic channel;
introducing a second fluid comprising a magnetic fluid into the microfluidic channel through a second inlet located after the first inlet to combine the second fluid with the first fluid to form a third fluid, and hydrodynamically focusing the third fluid into a sheath flow, wherein the third fluid includes components of the first fluid and the second fluid;
exposing the third fluid to a magnetic field produced by one or more magnets positioned adjacent and along a length of an area of the microfluidic channel after the second inlet, wherein the magnets have a flux density of about 0 T to about 10 T and a magnetic gradient of about 0 to about 1000 T/m, and wherein the magnetic field produces a magnetization direction substantially perpendicular to the flow of the third fluid in the microfluidic channel;
separating the components of the third fluid as a function of component size and width of the microfluidic channel; and
collecting portions of the components of the third fluid in two or more outlet channels positioned after the one or more permanent magnets at the second end of the microfluidic channel.

2. The method of claim 1, wherein the magnetic fluid is a ferrofluid comprising magnetic particles, wherein the ferrofluid concentration is tunable from about 0% to 10% volume fraction of the magnetic particles in the ferrofluid, wherein the concentration is tuned based on volume fraction of the magnetic particles and the size of the components.

3. (canceled)

4. The method of claim 1, wherein the magnetic fluid is a colloidal mixture of magnetic nanoparticles covered by a surfactant, suspended in a compatible carrier medium;
wherein the magnetic particles are selected from the group consisting of: iron oxide particles, cobalt particles, cobalt ferrite particles, iron particles, FePt particles, and a combination thereof;
wherein the surfactant comprises an electric double layer surfactant, polymer surfactant, inorganic surfactant, or a combination thereof; and
wherein the carrier medium comprises water, hydrocarbon oil, kerosene, or a combination thereof.

5. The method of claim 4, wherein the magnetic particles are maghemite nanoparticles, wherein the surfactant is a polymer surfactant, and the carrier comprises water.

6. The method of claim 1, wherein the cell mixture comprises unlabeled circulating tumor cells and white blood cells.

7. (canceled)

8. The method of claim 1, wherein the throughput is about 10¹³ to 10¹⁴ cells/hour/cm² of channel cross-section to process about 6.0 to 7.0 mL of the first fluid within 1 hour.

9. The method of claim 1, wherein about 90% or more of the circulating tumor cells in the first fluid are recovered, wherein greater than about 95% of white blood cells in the first fluid are separated from the cell mixture, or a combination thereof.

10. The method of claim 1, wherein the magnetic fluid comprises maghemite nanoparticles (Fe₂O₃) coated with polymethyl methacrylate-polyethylene glycol (PMMA-PEG) and 10% (v/v) 10× Hank's balanced salt solution (HBSS).

11. (canceled)

12. The method of claim 1, further comprising filtering the first fluid prior to introducing the second fluid.

13. The method claim 1, wherein the microfluidic channel is a curved microfluidic channel having at least one curve of about 120° to about 300° located between the first end and second end, and where the first inlet is located before or along the first curve, and where the one or more magnets are positioned adjacent and along a length of an area of the curved microfluidic channel along or after the first curve.

14. A device, comprising:
a microfluidic channel having a first end and a second end;
a first inlet, wherein the first inlet is configured to flow a first fluid into the microfluidic channel;
a second inlet located after first inlet, wherein the second inlet is configured to combine a second fluid with the first fluid to create a third fluid, and to hydrodynamically focus the third fluid into a stream by sheath flow;
one or more magnets positioned adjacent and along the length of an area of the microfluidic channel after the first inlet, wherein the magnets are positioned so that the magnetic field produces a magnetization direction substantially perpendicular to the flow of fluid in the microfluidic channel, and wherein the magnet has a flux density of about 0 T to about 10 T and a magnetic field gradient applied to the third fluid is about 0 T/m to about 1000 T/m; and
two or more outlet channels positioned after the one or more permanent magnets at the second end of the microfluidic channel.

15. The device of claim 14, wherein the microfluidic channel has a width of about 100 μm to about 1 cm, wherein the microfluidic channel has a depth of about 10 μm to about 1 mm, and wherein the microfluidic channel has a length of about 1 cm to about 10 cm.

16. The device of claim 14, further comprising a filtration region between the first inlet and the second inlet.

17. The device of claim 14, wherein the microfluidic channel is a curved microfluidic channel having at least a first curve between the first end and second end;
wherein the first inlet is before or along the first curve, and the second inlet is located after the first inlet and along or after the first curve, wherein an angle of curvature of the first curve is about 120° to about 300°; and
wherein the one or more magnets are positioned adjacent and along the length of an area of the curved microfluidic channel after the first inlet and along or after the first curve.

18. The device of claim 14, wherein the width of the microfluidic channel widens after the first inlet.

19. The device of claim 14, wherein the outlet channels have the same or different diameters and independently each have a diameter at the opening of about 10 μm to about 1 cm.

20. (canceled)

21. (canceled)

22. The device of claim 14, further comprising one or more collection chambers, wherein the collection chambers are coupled to the outlet channels.

23. A separation and collection system, comprising:
a fluid introduction system configured to introduce a first fluid and a second fluid to a microfluidic channel, wherein the fluid introduction system is configured to introduce the first fluid before the second fluid, wherein the first fluid and the second fluid mix in the microfluidic channel to form a third fluid;
a magnetic system configured to produce a magnetic field having a magnetization direction substantially perpendicular to the flow of the third fluid in the microfluidic channel after the second fluid is introduced to the microfluidic channel, and wherein the magnet has a flux density of about 0 T to about 10 T; and
a collection system configured to collect one or more components of the third fluid in two or more collection chambers, wherein each collection chamber is coupled to an outlet channel of the microfluidic channel.

24. The collection system of claim 23, further comprising a filtration system, wherein the filtration system is configured to filter the first fluid before the first fluid is mixed with the second fluid.

25. The separation and collection system of claim 24, wherein
the microfluidic channel is a curved microfluidic channel including a first curve having a degree of curvature of about 120 to 300 degrees, wherein the fluid introduction system is configured to introduce first fluid before or along the first curve and the fluid introduction system is configured to introduce the second fluid after or along the first curve, wherein the first fluid and the second fluid mix in the curved microfluidic channel to form a third fluid; and
the magnetic system is configured to produce a magnetic field having a magnetization direction substantially perpendicular to the flow of the third fluid in the curved microfluidic channel after the second fluid is introduced to the curved microfluidic channel.
